(19) United States
(12) Patent Application Publication
(10) Pub. No.: US 2023/0046547 A1
(43) Pub. Date: Feb. 16, 2023

(54) VIDEO PROCESSING METHOD AND APPARATUS, COMPUTER DEVICE, AND STORAGE MEDIUM

(71) Applicant: TENCENT TECHNOLOGY (SHENZHEN) COMPANY LIMITED, Shenzhen (CN)

(72) Inventors: Meihua XIE, Shenzhen (CN); Gang LING, Shenzhen (CN)

(73) Assignee: TENCENT TECHNOLOGY (SHENZHEN) COMPANY LIMITED, Shenzhen (CN)

(21) Appl. No.: 17/976,281

(22) Filed: Oct. 28, 2022

Related U.S. Application Data
(63) Continuation of application No. PCT/CN2022/079641, filed on Mar. 8, 2022.

(30) Foreign Application Priority Data
Mar. 17, 2021 (CN) 202110286371.0

(51) Int. Cl. H04N 21/8545; H04N 21/431; H04N 21/239; H04N 21/2743

(52) U.S. Cl. CPC H04N 21/8545; H04N 21/4312; H04N 21/2393; H04N 21/2743

(57) ABSTRACT

A video processing method includes playing a first video posted by a first account, the first video being obtained by photographing a real creature, the first video including a resource transmission access, the resource transmission access instructing to transmit a first type of resource to the first account, and the first type of resource being exchanged for a target type of supply used by the real creature in the first video, and transmitting, based on a triggering operation for the resource transmission access during the playing of the first video, the first type of resource of a second account currently logged in to the first account.

### CROSS-REFERENCE TO RELATED APPLICATIONS

This application is a continuation application of International Application No. PCT/CN2022/079641, filed on Mar. 8, 2022, which claims priority to Chinese Patent Application No. 202110286371.0, filed with the China National Intellectual Property Administration, on Mar. 17, 2021, the disclosures of each of which being incorporated by reference herein in their entireties.

### FIELD

The disclosure relates to the field of Internet technologies, in particular, to a video processing method and apparatus, a computer device, a storage medium, and a program product.

### BACKGROUND

With the rapid development of Internet technologies, a variety of cultivation games are more and more popular. For example, in a game for raising a virtual pet, a user upgrades the virtual pet by performing a task in the game, and the user can get a corresponding reward after the virtual pet is upgraded.

However, in this way, since the virtual pet is a pet existing in a game, and the pet is upgraded using a mobile terminal only by performing game tasks, an interaction process between the user and the virtual pet lacks realism, resulting in a low human-computer interaction rate and a poor human-computer interaction effect.

### SUMMARY

According to various embodiments, a video processing method, performed by a computer device, may include: playing a first video posted by a first account, the first video being obtained by photographing a real creature, the first video including a resource transmission access, the resource transmission access instructing to transmit a first type of resource to the first account, and the first type of resource being exchanged for a target type of supply used by the real creature in the first video; and transmitting, based on a triggering operation for the resource transmission access during the playing of the first video, the first type of resource of a second account currently logged in to the first account.

According to various embodiments, a video processing method, performed by a computer device, may include: acquiring a first video on the basis of a first account currently logged in, the first video being obtained by photographing a real creature, the first video including a resource transmission access, the resource transmission access instructing to trigger an account of the resource transmission access to transmit a first type of resource to the first account, and the first type of resource being exchanged with a target type of supply used by the real creature in the first video; and posting the first video on the basis of the first account, the posted first video transmitting, based on a triggering operation for the resource transmission access in the first video during the playing of the first video by a second terminal of a second account currently logged in, the first type of resource of the second account currently logged in to the first account.

According to various embodiments, a video processing method, performed by a computer device, may include: receiving a resource transmission request, the resource transmission request being transmitted by a second terminal based on a triggering operation for a resource transmission access in a first video during the playing of the first video, the first video being obtained by photographing a real creature, the resource transmission access instructing to transmit a first type of resource to a first account that posts the first video, and the first type of resource being exchanged for a target type of supply used by the real creature in the first video; and transmitting the first type of resource of a second account logged in by the second terminal to the first account.

According to various embodiments, a video processing apparatus, a computer device, a non-volatile computer-readable storage medium, and a computer program product or a computer program consistent with the foregoing methods may also be provided.

### BRIEF DESCRIPTION OF THE DRAWINGS

To describe the technical solutions of some embodiments of this disclosure more clearly, the following briefly introduces the accompanying drawings for describing the some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of an implementation environment provided according to some embodiments.

FIG. 2 is a schematic diagram of another implementation environment provided according to some embodiments.

FIG. 3 is a system architecture diagram of a video processing method provided according to some embodiments.

FIG. 4 is a flow chart of a video processing method provided according to some embodiments.

FIG. 5 is a flow chart of a video processing method provided according to some embodiments.

FIG. 6 is a flow chart of a video processing method provided according to some embodiments.

FIG. 7 is a flow chart of another video processing method provided according to some embodiments.

FIG. 8 is a schematic diagram of a first video provided according to some embodiments.

FIG. 9 is a schematic diagram of a process for acquiring a first video provided according to some embodiments.

FIG. 10 is a schematic diagram of a process for following an account provided according to some embodiments.

FIG. 11 is a schematic diagram of a process for exchanging a first type of resource provided according to some embodiments.

FIG. 12 is a schematic diagram of a process for exchanging a first type of resource provided according to some embodiments.

FIG. 13 is a schematic diagram of a process for playing a video provided according to some embodiments.

FIG. 14 is a schematic diagram of a process for transmitting a first type of resource provided according to some embodiments.

FIG. 15 is a schematic diagram of increasing an intimacy parameter provided according to some embodiments.

FIG. 16 is a schematic diagram of displaying various kinds of information provided according to some embodiments.

FIG. 17 is a schematic diagram of a process for exchanging a target type of supply provided according to some embodiments.

FIG. 18 is a schematic structural diagram of a video processing apparatus provided according to some embodiments.

FIG. 19 is a schematic structural diagram of another video processing apparatus provided according to some embodiments.

FIG. 20 is a schematic structural diagram of another video processing apparatus provided according to some embodiments.

FIG. 21 is a schematic structural diagram of another video processing apparatus provided according to some embodiments.

FIG. 22 is a schematic structural diagram of another video processing apparatus provided according to some embodiments.

FIG. 23 is a schematic structural diagram of another video processing apparatus provided according to some embodiments.

FIG. 24 is a schematic structural diagram of a terminal according to some embodiments.

FIG. 25 is a schematic structural diagram of a server according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict.

It may be understood that the terms “first”, “second”, and the like used in the embodiments may be used for describing various concepts in this specification. However, the concepts are not limited by the terms unless otherwise specified. The terms are merely used for distinguishing one concept from another concept. For example, without departing from the scope of the disclosure, a first terminal may be referred to as a second terminal, and similarly, the second terminal may be referred to as the first terminal.

“At least one” refers to “one or more”. For example, “at least one terminal” may refer to any integral number of terminals, the integral number being greater than or equal to one, for example, one terminal, two terminals, or three terminals. “A plurality of” refers to “two or more”. For example, “a plurality of terminals” may refer to any integral number of terminals, the integral number being greater than or equal to two, for example, two terminals or three terminals. Each refers to each of at least one, for example, each terminal refers to each of a plurality of terminals. If the plurality of terminals mean three terminals, each terminal refers to each of the three terminals.

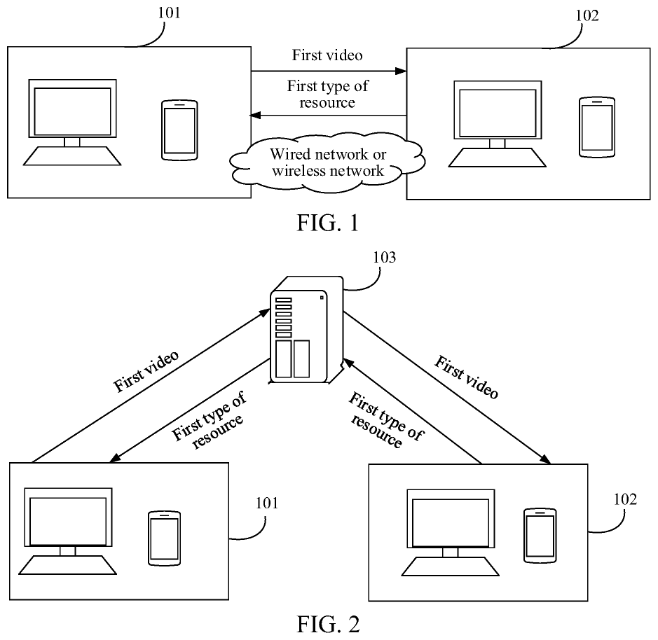

FIG. 1 is a schematic diagram of an implementation environment provided according to some embodiments. Referring to FIG. 1, the implementation environment includes: a first terminal 101, and a second terminal 102. The first terminal 101 and the second terminal 102 may be a smartphone, a tablet computer, a notebook computer, a desktop computer, a smart speaker, a smartwatch, smart TV, smart in-vehicle terminal or the like, but are not limited thereto. The first terminal 101 and the second terminal 102 may be directly or indirectly connected in a wired or wireless communication manner. This is not limited herein. The first terminal 101 is configured to post a first video, and the second terminal 102 is configured to play the first video and pay a corresponding first type of resource for the first video. In some embodiments, a target client is installed on the first terminal 101 and the second terminal 102. The first terminal 101 may achieve functions such as video photographing, video uploading, and video editing via the target client, and the second terminal 102 may achieve functions such as video playing and resource exchange via the target client. In some embodiments, the target client is a target client in operating systems of the first terminal 101 and a plurality of second terminals 102, or a target client provided by a third party. In some embodiments, the client may be a video playing client, a browser client, an instant messaging client, an education client, and the like.

In some embodiments, as shown in FIG. 2, the implementation environment further includes a server 103. The server 103 may be an independent physical server, or may be a server cluster or a distributed system formed by a plurality of physical servers, or may be a cloud server that provides a basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform. The first terminal 101 and the second terminal 102 are directly or indirectly connected to the server in a wired or wireless communication manner. This is not limited herein. The server 103 is configured to post the first video uploaded by the first terminal 101 in the second terminal 102, and the server 103 is also configured to perform, when the second terminal 102 consumes the first video posted by the first terminal, corresponding resource transferring. In some embodiments, a target client served by the server 103 is installed on the first terminal 101 and the second terminal 102, and the server 103 is a background server of the target client or a cloud server providing services such as cloud computing and cloud storage.

In some embodiments, a server is a server for managing creature videos. A platform for interaction based on a creature video is provided. Any terminal can access the platform by the target client provided by the server. When making a registration in the target client using a terminal, a user can register own creatures. For example, a registered account is the name of the creature. Later, the user can post videos of the creature in the target client, and other users can play the videos, so that other users can also watch the growth of the creature of the user through the target client.

In some embodiments, the second terminal 102 plays a first video posted by a first account, the first video being obtained by photographing a real creature, the first video including a resource transmission access, the resource transmission access being used for instructing to transmit a first type of resource to the first account, and the first type of resource being used for being exchanged for a target type of supply used by the creature in the first video. The second terminal 102 transmits, in response to a triggering operation for the resource transmission access, the first type of resource of a second account currently logged in to the first account.

Since the first video includes a real creature, the user of the second terminal can directly pay the first type of resource to the account posting the first video in the process of playing the first video. The first type of resource can be exchanged for a real target type of supply. In this manner of directly transmitting the first type of resource to the first account through the resource transmission access in the first video in the process of playing the video, the user can get real benefits to the account posting the video in the process of watching the video. Compared with an existing manner that the user needs to perform game tasks to obtain resources for a virtual creature, or that resources are transmitted through an additional resource interface, this manner is more convenient, without skipping to other interfaces to transmit resources, so that the running resources of the terminal can be saved.

The video processing method provided according to some embodiments can be applied to any scenario of playing a video, for example, a scenario of playing a pet video. The pet video refers to a video obtained by photographing a real pet, and the real pet can be various types of animals or plants, and the like.

In this scenario, a virtual like is set in the target client. The virtual like is a virtual resource circulating in the target client. A producer may produce a pet video according to a real living state and a growing process of a pet, add a sticker as a resource transmission access in the pet video, and then post the pet video in the target client. An adopter may watch the pet video, and award a virtual like to the producer by clicking the sticker in the pet video in the process of watching the video. Later, the producer may use the received virtual like to exchange for pet supplies in the target client.

A novel video playing manner is provided in this application scenario. In the video playing process, a process of adopting a pet is simulated by presenting the virtual like to the pet video. By recording the real life state of the pet, the producer transmits an offline pet raising behavior to the adopter in the form of an interactive video, so as to restore the scenario of raising the pet in the real life, abundant and real. Moreover, the adopter can watch a very emotional form, growing process, and the like of the pet through the pet video, so as to learn about the growth of the pet in the real life. At the same time, the virtual like paid by the adopter for the pet video can be exchanged for real living supplies for the pet, so that the pet can get real benefits, and the emotion given by the adopter is more meaningful, which gives the adopter a greater sense of accomplishment. In addition, in the process of playing the pet video, it is convenient to present the virtual like through the sticker in the pet video, without skipping to other interfaces to transmit the virtual like, so that the running resources of the terminal can be saved.

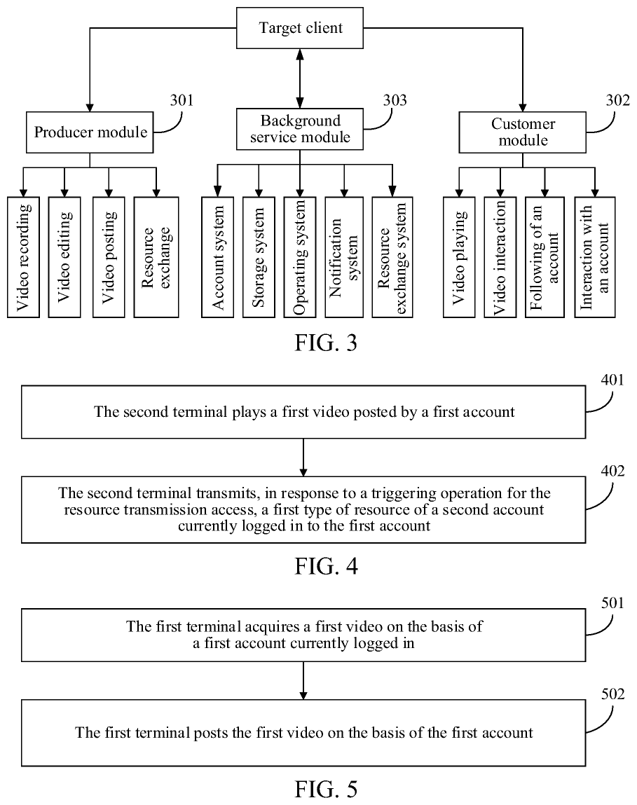

FIG. 3 is system architecture diagram of a video processing method provided according to some embodiments. Referring to FIG. 3, a system architecture of the video processing method includes a producer module 301, a consumer module 302, and a background service module 303. The producer module 301 refers to a first terminal for photographing, editing and posting a video. The producer module 301 runs a target client provided by the background service module 303. The consumer module 302 refers to a second terminal for watching and consuming a video. The consumer module 302 runs the target client provided by the background service module 303. The producer module 301 acquires a first type of resource by photographing, editing and posting a video including a real creature, thereby exchanging the acquired first type of resource for supplies of the creature. After obtaining the first type of resource by purchasing or other actions, the consumer module 302 transmits the first type of resource during the consumption of the video and may view the supplies that are exchanged by the first type of resource. For example, the real creature is a pet raised by a user, such as a kitten or puppy.

The producer module 301 includes functions such as video recording, video editing, video posting, and resource exchange. The video recording refers to obtaining a video segment containing the real creature using a filming capability, and entering a video editing interface after obtaining the video segment, or also acquiring a locally stored video segment and entering the video editing interface. The video editing interface includes an editing function of a start-to-play time point of the video segment, and an editing function of a resource transmission link in the video segment. The editing function of the resource transmission link includes an editing function of information such as a display element, display information, and resource number of the resource transmission link. The video posting refers to merging multiple video segments into one video, packing the information about the resource transmission link into the video, and uploading same to the background service module 303. The resource exchange refers to exchanging the first type of resource for a target type of supply, and uploading an exchange record to the background service module 303.

The consumer module 302 includes functions such as video playing, interaction with a video, following of an account, and interaction with an account. The video playing refers to an ability of playing a video, including abilities of playing and pausing a video. The interaction with a video refers to an ability of interacting with the video, including a like function, a comment function, a forward function, and the like, which make the process of watching the video sociable. The following of an account means that an association relationship between accounts will be generated after the account of the consumer module 302 follows the account of the producer module 301, and the association relationship will be recorded in the background service module 303. The interaction with an account means that a resource transmission access will be displayed in the process of playing a video, and the complete video can be played only after the consumer module 302 transmits the first type of resource to the produce module 301.

The background service module 303 includes an account system, a storage system, an operating system, a notification system, and a resource exchange system. The account system includes a registration login system and payment consumption system of a user, an association relationship between the account of the producer module 301 and the account of the consumer module 302, and the like. The storage system is configured to store the video posted by the producer module 301 and information related to the resource transmission access corresponding to the video. The operating system includes functions such as video review and video recommendation. The video review is used for reviewing whether a posted video meets a posting requirement, and a video includes an approved state and an unapproved state. An unapproved video will be informed to the producer module 301 of the video through the notification system. The video recommendation is used for scoring and recommending videos, such as scoring a video on the basis of the number of likes, the number of views, and the number of followers of the video, or recommending the video according to the type of the video. The notification system is configured to reach the producer module 301 or the consumer module 302 and transmit a notification message to the producer module 301 or the consumer module 302. The resource exchange system is configured to configure a target type of supply and provide the target type of supply to the producer module 301.

FIG. 4 is a flow chart of a video processing method provided according to some embodiments. An executive body of some embodiments is a second terminal. Referring to FIG. 4, the method includes:

401. The second terminal plays a first video posted by a first account.

The second terminal plays the received first video, the first video being a video posted by the first account, the first video being obtained by photographing a real creature, the first video including a resource transmission access, the resource transmission access being used for instructing to transmit a first type of resource to the first account, and the first type of resource being used for being exchanged for a target type of supply used by the creature in the first video.

The real creature is any type of creature, for example, a kitten, a puppy, a bird, or other animals, and for example, a sensitive plant, peony, lily, or other plants. The first type of resource is a virtual gold coin, a virtual like, a virtual red bag, and the like. The target type of supply is an item used by the real creature. For example, the target type of supply is dog food, cat food, a pet toy or cat house, and the like.

402. The second terminal transmits, in response to a triggering operation for the resource transmission access, the first type of resource of a second account currently logged in to the first account.

In the process of playing the first video, the second terminal may display the resource transmission access in the first video; if a user wants to present the first type of resource to the first account, the user performs a triggering operation on the resource transmission access; and the second terminal, in response to the triggering operation for the resource transmission access, transmits the first type of resource of the second account currently logged in to the first account, thereby completing presenting the resource in the process of playing the video.

Some embodiments provide a novel video processing manner. The first video includes the real creature. When watching the first video, the user pays the first type of resource to the account posting the first video. The first type of resource can be exchanged for the real target type of supply, so that the account posting the video can get real revenue when the user watches the video, and the interaction process between the user and the creature in the video is more realistic; and the posting and playing form of the video is also enriched.

FIG. 5 is a flow chart of a video processing method provided according to some embodiments. An executive body of some embodiments is a first terminal. The explanation of the concepts and operations in this embodiment can refer to the description of other embodiments in the foregoing content. Referring to FIG. 5, the method includes:

501. The first terminal acquires a first video on the basis of a first account currently logged in.

In some embodiments, the first video is a video currently photographed by the first terminal, or a video stored locally in the first terminal. In some embodiments, after acquiring a video obtained by photographing a real creature, the first terminal adds a resource transmission access to the video to obtain the first video.

502. The first terminal posts the first video on the basis of the first account.

After acquiring the first video, the first terminal posts the first video on the basis of the first account, and the second terminal receiving the first video then plays the first video.

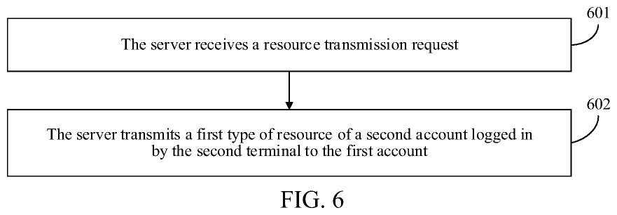

FIG. 6 is a flow chart of a video processing method provided according to some embodiments. An executive body of this embodiment of some embodiments is a server. The explanation of concepts and operations in this embodiment can refer to the descriptions of other embodiments in the foregoing content. Referring to FIG. 6, the method includes:

601. The server receives a resource transmission request.

The server receives the resource transmission request transmitted by the second terminal, the resource transmission request being transmitted by the second terminal in response to a triggering operation for a resource transmission access in a first video.

602. The server transmits a first type of resource of a second account logged in by the second terminal to the first account.

According to the resource transmission request, the server determines that a resource transmitter is the second account logged in by the second terminal, and determines that a resource receiver is the first account posting the first video, and the first type of resource of the second account is transmitted to the first account to complete transferring of the first type of resource.

Some embodiments provide a novel resource transfer manner. The first video includes a real creature, the user of the second terminal can transmits the resource transmission request to the server in the process of watching the first video, and the server transmits the first type of resource in the account through which the first video is watched to the account posting the first video; the first type of resource can be exchanged for a real target type of supply. In this manner of directly transmitting the first type of resource to the first account through the resource transmission access in the first video in the process of playing the video, the user can get real benefits to the account posting the video in the process of watching the video. Compared with an existing manner that the user needs to perform game tasks to obtain resources for a virtual creature, or that resources are transmitted through an additional resource interface, this manner is more convenient, without skipping to other interfaces to transmit resources, so that the running resources of the terminal can be saved.

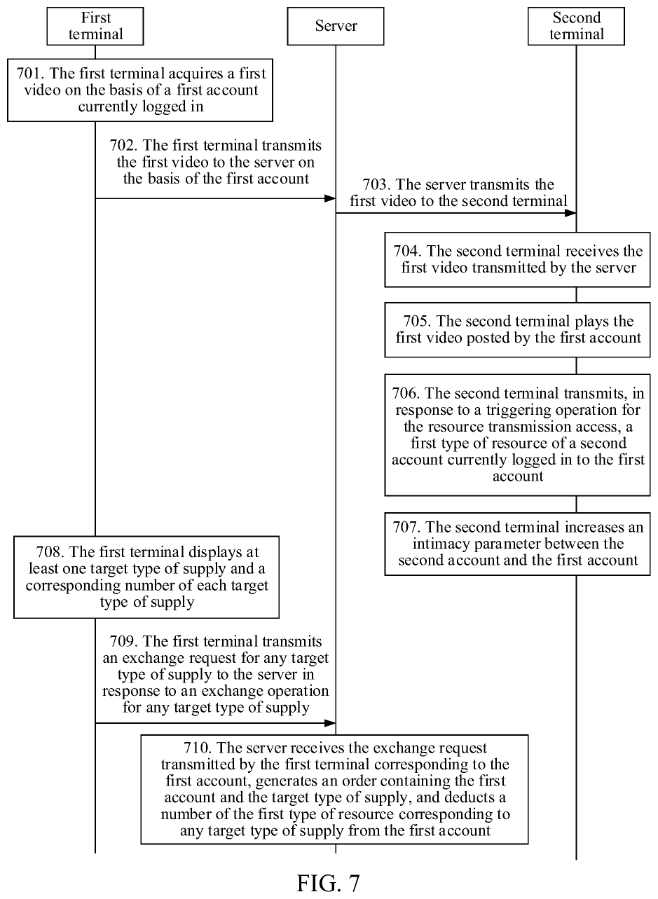

FIG. 7 is a flow chart of a video processing method provided according to some embodiments. Interactive bodies of some embodiments include a first terminal a second terminal, and a server. The explanation of concepts and operations of this embodiment may refer to the descriptions of other embodiments in the foregoing content. Referring to FIG. 7, the method includes:

701. The first terminal acquires a first video on the basis of a first account currently logged in.

The first type of resource is used for being exchanged for a target type of supply used by a creature in the first video. The creature in the first video belongs to a target creature type, and the target type of supply refers to items used by creatures belonging to the target creature type. For example, the target creature type to which the creature in the first video belongs is a dog, and the target type of supply used by the creature in the first video includes dog food, a dog house, a dog leash, or the like.

In the method provided by some embodiments, the first type of resource is a virtual resource circulating in the implementation environment, the implementation environment also provides a plurality of types of supplies, each type of supply corresponding to one creature type. Since the creature type in the first video belongs to a target creature type, the first type of resource acquired by the first account on the basis of the first video is exchanged for the target type of supply corresponding to the target creature type for use by the creature in the first video. In some embodiments, the first type of resource acquired by the first account on the basis of the first video carries a target creature identifier; when the first account exchanges the first type of resource for a supply in the later stage, whether the creature type corresponding to this supply is the same as the target creature identifier carried by the first type of resource; if the creature type is the same as the target creature identifier, the first type of resource is allowed to be exchanged for this supply; and if the creature type is not the same as the target creature identifier, the first type of resource is not allowed to be exchanged for this supply.

In some embodiments, a terminal acquires an original video. The original video is obtained by photographing a real creature, and the original video does not include a resource transmission access. If the user of the first terminal hopes a user watching the original video to transmit the first type of resource to him, the user needs to add a resource transmission access to the original video, so that the user performs an access adding operation on the original video. The first terminal acquires, in response to the access adding operation for the original video, a target display element input to an input box, or selects a target display element from a plurality of standby display elements; and determines the target display element as the resource transmission access, and adds the resource transmission access to the original video to obtain the first video.

The target display element may be any type of display element. For example, the target display element is a sticker, and the sticker includes at least one kind of a pattern or text. In some embodiments, the content of the sticker matches the content of the first video. For example, the creature in the first video is a dog. If the content of the first video is walking the dog, the sticker includes a pattern or text indicating “walking the dog”. In some embodiments, if the content of the first video is feeding a puppy, the sticker includes a pattern or text or the like indicating “feed”.

In some embodiments, the first terminal displays a video editing interface. The video editing interface is used for editing a video to be posted, and the video editing interface includes the acquired original video and an access adding option. The first terminal displays, in response to a triggering operation on the access adding option, the plurality of standby display elements, and determines, in response to a triggering operation of any one of the standby display elements, the standby display element as the target display element. The plurality of standby display elements displayed by the first terminal are various types of display elements, and the content of each type of standby display element is different. The user can select the standby display element matching the content of the first video from the plurality of displayed standby display elements as the target display element. In some embodiments, the user may also set the target display element by himself. For example, if the second terminal displays the input box in response to the triggering operation for the access adding option, the user may input a display element in the input box as the target display element.

In some embodiments, the first terminal may also adjust the size of the resource transmission access after adding the resource transmission access to the original video. If the user of the first terminal intends to adjust the size of the resource transmission access, the user performs a zooming operation on the resource transmission access to control the size of the resource transmission access. The first terminal determines, in response to the zooming operation for the resource transmission access, the size of the resource transmission access when the zooming operation is released, and determines this size as the size of the resource transmission access in the first video.

In some embodiments, the first terminal determines display information corresponding to the resource transmission access, and adds the display information to the original video to obtain the first video. The display information is used for indicating a display manner of the resource transmission access. After adding the display information to the original video, the first terminal displays the resource transmission access n the original video according to the display information, so as to obtain the first video including the resource transmission access. In some embodiments, the display information is a display position or a display time point of the resource transmission access, and the like. The display position refers to the display position of the resource transmission access in the first video, and the display time point refers to the display time point of the resource transmission access in the first video. In some embodiments, the display position or the display time point, and the like of the resource transmission access in the first video is determined by setting the display information corresponding to the resource transmission access, which improves the flexibility of the display manner of the resource transmission access.

In some embodiments, the first terminal determines the display time point corresponding to the resource transmission access, including: displaying a play progress bar of the first video, and determining a play time point selected from the play progress bar as the display time point corresponding to the resource transmission access. If the user of the first terminal intends to adjust the display time point of the resource transmission access in the first video, the user performs a dragging operation on the play progress bar, and the first terminal determines a play time point corresponding to a position where the play progress bar is dragged, and determines the play time point as the display time point corresponding to the resource transmission access. Or, the user performs a click operation on the play progress bar, and the first terminal determines a play time point corresponding to a position of the click operation, and determines the play time point as the display time point corresponding to the resource transmission access. Some embodiments provide the play progress bar of a first video, which facilitates the user to directly set the display time point of the resource transmission access by performing the triggering operation on the play progress bar, thus improving the convenience of setting the display time point; and furthermore, the display timing of the resource transmission access can be represented more intuitively, and the visualizing effect of setting the display time point is enhanced.

In some embodiments, the first terminal determines the display position corresponding to the resource transmission access, including: determining, in response to the dragging operation for the resource transmission access, a position where the dragging operation is released, and determining the position as the display position corresponding to the resource transmission access. If the user intends to adjust the display position of the resource transmission access in the first video, the dragging operation is performed on the resource transmission access in the first video to control the adjustment of the display position corresponding to the resource transmission access, and the second terminal determines that a position where the dragging operation is released is the display position corresponding to the resource transmission access.

In some embodiments, the first terminal determines a first number corresponding to the resource transmission access, and adds the first number to the original video to obtain the first video. The first number corresponding to the resource transmission access refers to the number, indicated by the resource transmission access, of the first type of resource transmitted to the first account, and the resource transmission access instructs the account triggering the resource transmission access to transmit the first type of resource in the first number to the first account.

In some embodiments, if the user intends to set the number corresponding to the resource transmission access, a number setting operation for the resource transmission access is performed, and the terminal acquires, in response to the number setting operation for the resource transmission access, the first number input or selected by the user.

In some embodiments, the first terminal acquires a plurality of video segments; each video segment includes a creature and a resource transmission access; and the first terminal merges the plurality of video segments into the first video. Each video segment includes the same creature, and the content of each video segment is different. Since each video segment includes the resource transmission access, the merged first video may include a plurality of resource transmission accesses, and each resource transmission access is used for instructing to transmit the first type of resource to the first account, that is, the first type of resource may be transmitted to the first account for multiple times by watching the first video.

In some embodiments, the first terminal displays a video adding option in a video editing interface. One video segment is acquired at each time in response to a triggering operation for the video adding option, until the plurality of acquired video segments are merged into the first video in response to a video segment merging operation. The video editing interface is used for editing a video to be posted. If the user intends to add a video segment, the user performs a triggering operation on the video adding option; and the first terminal acquires one video segment in response to the triggering operation for the video adding option. If the user intends to continue to add a video segment, the user continues to perform the triggering operation on the video adding option; and the first terminal continues to acquire one video segment. When the first terminal acquires a plurality of video segments, if the user determines that sufficient video segments have been added, the user performs the video segment merging operation on the plurality of video segments, and the terminal merges the plurality of video segments into the first video in response to the video segment merging operation for the plurality of video segments.

In some embodiments, after acquiring one video segment in response to the triggering operation on the video adding option at each time, the first terminal displays the video segment acquired this time, cancels displaying the video adding option, and re-displays, in response to a sliding operation for the currently displayed video segment, the video adding option. After the first terminal displays the video segment acquired this time and cancels displaying the video adding option, the user may perform an editing operation on the video segment on the basis of the video editing interface, where the editing operation for the video segment including operations such as adding a resource transmission access in the video segment. After the user finishes editing the video segment, if the user intends to continue to add video segments, the user performs the sliding operation on the currently displayed video segment to cause the first terminal to re-display the video adding option, and the user may continue to add a next video segment on the basis of the video adding option. The sliding operation for the video segment includes an up-sliding operation, a down-sliding operation, a left-sliding operation, a right-sliding operation, or the like. For example, if the user performs the left-sliding operation on the video segment, the first terminal re-displays the video adding option on the right side of the video segment.

In some embodiments, the terminal acquires, in response to a text inputting operation for the original video, text information corresponding to the original video, and adds the acquired text information to the original video to obtain the first video. In some embodiments, the text information is text information for introducing or describing the first video. For example, if the content of the first video is feeding a puppy, the text information in the first video is “I have been sleeping for a long time. I am so hungry. Feed me”, and the like. In some embodiments, by adding text information to a video, the information content displayed in the video is improved, so that a user can learn the content of the video according to the text information.

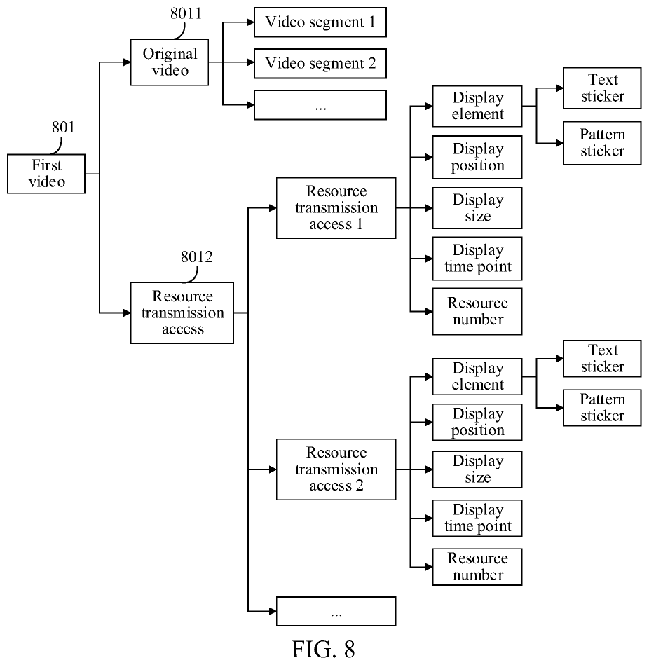

FIG. 8 is a schematic diagram of a first video provided according to some embodiments. As shown in FIG. 8, a first video 801 includes an original video 8011, and a resource transmission access 8012 added to the original video 8011. The original video 8011 includes a plurality of video segments, such as video segment 1 and video segment 2, and the resource transmission access 8012 includes a plurality of resource transmission access, such as resource transmission access 1 and resource transmission access 2. With regard to each resource transmission access, the resource transmission access corresponds to information such as a display element, a display position, a display size, a display time point, and a resource number, and the display element includes elements such as a text sticker or a pattern sticker.

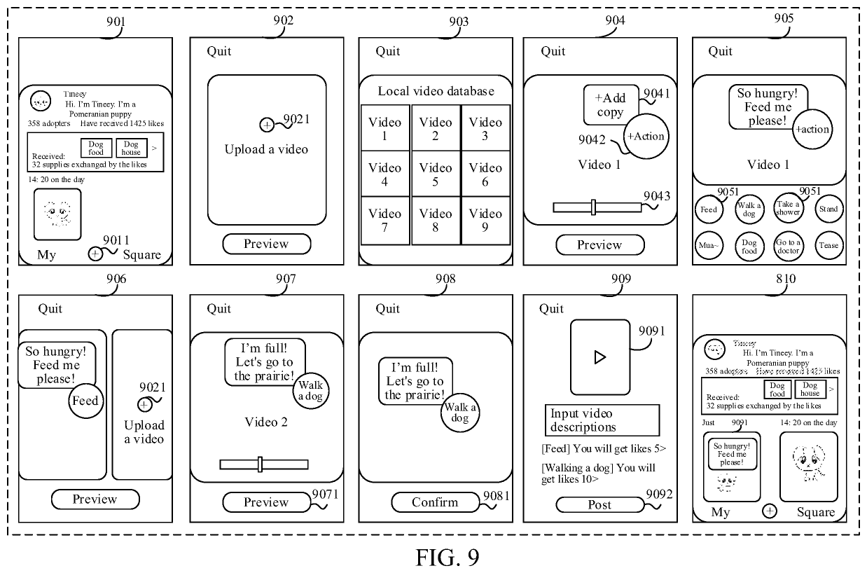

FIG. 9 is a schematic diagram of a process for acquiring a first video provided according to some embodiments. Referring to FIG. 9, a first terminal displays a main interface 901 of a first account, and the main interface 901 includes a video editing option 9011. The first terminal displays a video editing interface 902 in response to a triggering operation for the video editing option, and the video editing interface 902 includes a video segment adding option 9021. The first terminal displays a video database interface 903 in response to a triggering operation for the video segment adding option 9021, and the video database interface 903 includes a plurality of videos locally stored in the first terminal. The first terminal uploads video 1 to a video editing interface 904 in response to a triggering operation for video 1 in the plurality of videos.

As shown in FIG. 9, the video editing interface 904 includes video 1, and a text input box 9041, a sticker adding option 9042 and a play progress bar 9043 which correspond to video 1. The sticker adding option 9042 is used for adding a sticker as a resource transmission access. The first terminal acquires, in response to a triggering operation for the text input box 9041, a text “So hungry! Feed me please!” inputted into the text input box 9041, and adds this text to video 1. The first terminal displays a plurality of action stickers 9051 in response to a triggering operation for the sticker adding option 9042. The first terminal determines, in response to a triggering operation for a “feed” action sticker, the “feed” action sticker as a resource transmission access and adds the same to Video 1. The user may adjust the display position of the action sticker in Video 1 by dragging the action sticker, adjust the size of the action sticker by zooming the action sticker, and adjust the display time point of the action sticker in Video 1 by dragging the play progress bar 9043.

As shown in FIG. 9, the first terminal displays edited Video 1 in a video editing interface 906, and re-displays, in response to the left-sliding operation for Video 1, the video segment adding option 9021 on the right side of Video 1. The first terminal adds, in response to a triggering operation for the video segment adding option 9021, acquired Video 2 to a video editing interface 907, and adds a resource transmission access for Video 2 in the video editing interface 907. The video editing interface 907 further includes a preview option 9071. The first terminal plays edited Video 1 and Video 2 in a video editing interface 908 in response to a triggering operation for the preview option 9071. The video editing interface 908 further includes a video segment merging option 9081. The first terminal merges Video 1 and Video 2 into a first video 9091 in response to a triggering operation for the video segment merging option 9081.

As shown in FIG. 9, the first terminal displays the merged first video 9091 in a video editing interface 909. The first type of resource being a virtual like is taken as an example. The first terminal determines, on the basis of a number setting operation performed in the video editing interface 909, that the number of virtual likes corresponding to the “feed” action sticker in Video 1 is 5 and that the number of virtual likes corresponding to the “walking a dog” action sticker in Video 2 is 10. The video editing interface 909 further includes a posting option 9092. The first terminal posts, in response to a triggering operation for the posting option 9092, the first video 9091, and displays the posted first video 9091 in the main interface 810 of the first account.

702. The first terminal transmits the first video to the server on the basis of the first account.

The first terminal transmits the first video to the server on the basis of the first account, and the server posts the first video.

In some embodiments, a target client provided by the server is run in the first terminal, and a communication connection is established with the server via the target client. For example, the target client is a video playing client, a browser client, an instant messaging client, an education client, etc. with a video editing function. The first terminal acquires the first video from the target client, and transmits the first video to the server via the target client.

703. The server transmits the first video to the second terminal.

The server receives the first video transmitted by the first terminal, and transmits the first video to at least one second terminal, so as to post the first video of the first terminal to other terminals. In some embodiments, the server acquires the first video transmitted by the first terminal on the basis of the first account, queries a second account that follows the first account, and transmits the first video to the second terminal corresponding to the second account.

Follow relationships between the first account and other accounts are stored in the server. The follow relationship indicates that other accounts follows the first account. Therefore, the server queries, on the basis of the follow relationship, the second account that follows the first account, and determines the second terminal corresponding to the second account. The second terminal corresponding to the second account refers to a second terminal that determines to log in the second account, and the first video is transmitted to the second terminal. That is, the server pushes the first video of the first account to the second account that follows the first account.

In some embodiments, the second account follows the first account, which can be equivalent to that the second account “adopts” the creature in the video posted by the first account. For example, if the video posted by the first account including a pet dog, this can be equivalent to that the second account “adopts” the pet dog of the first account. Therefore, after the first account posts the first video including the pet dog, the server pushes the first video to the second account, so that the user of the second account plays the first video in time and watches the pet dog in the first video, thereby realizing a scenario of simulating pet adoption.

In some embodiments, the server acquires the first video transmitted by the first terminal corresponding to the first account, and identifies the creature in the first video to obtain a first creature identifier. The first creature identifier indicates the creature in the first video. The server queries at least one account associated with the first creature identifier. The at least one account associated with the first creature identifier includes at least a second account. The server transmits the first video to a terminal corresponding to the at least one account.

In some embodiments, an association relationship between a creature identifier and an account is stored in the server. Therefore, the server queries at least one account associated with the first creature identifier on the basis of the association relationship. The at least one account includes a second account. The server determines a second terminal corresponding to the second account. The second terminal corresponding to the second account refers to a second terminal that determines to log in the second account, and the first video is transmitted to the second terminal. That is, the server pushes the first video of the first account to the second account having the association relationship with the creature identifier corresponding to the creature in the first video.

In some embodiments, the first account posts the first video including the creature indicated by the first creature identifier. In addition, the first account may also post videos of creatures indicated by other creature identifiers. That is, the first account may post a plurality of videos, and the creature in each video may be the same or different. Furthermore, by establishing the association relationship between the second account and any creature identifier, after a video including a creature indicated by the creature identifier is posted subsequently, the video will be pushed to the second account, so as to simulate the scenario in which the second account “adopts” the creature indicated by the creature identifier.

In some embodiments, the server acquires the first video transmitted by the first terminal corresponding to the first account and a creature type corresponding to the first video, and transmits the first video and the creature type to the second terminal. The second terminal displays a playing access of the first video in a video recommendation interface. The video recommendation interface is used for displaying the playing access of the video which is recommended to the second account and corresponds to the creature type. The creature type corresponding to the first video refers to the species, such as cat, dog, plant, or the like, to which the creature in the first video belongs. In some embodiments, the creature type corresponding to the first video is transmitted by the first terminal to the server, or is determined by the server by identifying the first video. This is not limited herein. Since the server transmits both the first video and the creature type corresponding to the first video to the second terminal, it is convenient for the second terminal to play the first video in the video recommendation interface corresponding to the creature type.

In some embodiments, the server receives the first video transmitted by the first terminal, and validates the first video. If the first video satisfies a posting specification, the server determines that the validation of the first video succeeds, and transmits the first video to the second terminal. If the first video does not satisfy the posting specification, the server determines that the validation of the first video fails, and returns validation failure prompt information to the first terminal.

In some embodiments, the server receives the first video transmitted by the first terminal on the basis of the first account, determines a historical posting condition of the first account, and recommends, on the basis of the historical posting condition of the first account, the first video. For example, the server determines, according to the numbers of likes of videos posted by the first account, the numbers of views of the videos, and the number of accounts that follow the first account, a score corresponding to the first video, and determines, on the basis of the score corresponding to the first video, the number of terminals that receive the first video.

It is noted that in the above-mentioned operations 702-703, illustrations is made only by taking “the first terminal transmits the first video to the server, and the server posts the first video to the second terminal” as an example, so as to realize that the second terminal posts the first video. In another embodiment, the first terminal may post the first video on the basis of the first account in other manners. For example, the first terminal directly transits the first video to the second terminal.

In some embodiments, the first terminal identifies the creature in the first video to obtain the first creature identifier, and the first creature identifier indicates the creature in the first video. The first terminal queries at least one account associated with the first creature identifier, the at least one account at least including a second account, and transmits the first video to a terminal corresponding to the at least one account. The process that the first terminal identifies a creature and transmits the first video to the second terminal is the same as the process that the server identifies a creature and transmits the first video to the second terminal in operation 703, and descriptions thereof will be omitted here.

704. The second terminal receives the first video transmitted by the server.

705. The second terminal plays the first video posted by the first account.

The second terminal receives the first video posted by the first account, and plays the first video.

In some embodiments, the second terminal displays a video display interface. Playing accesses of videos posted by the account followed by the second account in the video display interface. The videos posted by the account followed by the second account at least includes the first video. The second terminal plays the first video in response to a triggering operation for the playing access of the first video.

The video display interface is used for displaying the playing accesses of the videos posted by the account followed by the second account. The accounts followed by the second account includes the first account. Therefore, after the first account posts the first video, the second terminal will display the playing access of the first video in the video display interface. In some embodiments, the playing access is a playing card corresponding to the first video, but this is not limited herein. If the user intends to watch the first video corresponding to the playing access, the user performs a triggering operation on the playing access, and the first terminal plays the first video in response to the triggering operation for the playing access.

In some embodiments, the second terminal displays, in the video display interface, the playing accesses of the videos posted by the accounts followed by the second account and first prompt information corresponding to the videos. The first prompt information includes that the second account transmits, via the resource transmission accesses in the videos, the number of the first type of resource to the accounts that post the videos.

With regard to any video in the video display interface, if the second account has transmitted the first type of resource to an account that posts the video through the resource transmission access in the video, the second terminal displays the first prompt information corresponding to the video. For example, with regard to a certain video, if the user of the second account has already performed the triggering operation on the resource transmission access in the video in the process of watching the video, and transmitted the first type of resource of the second account to the account that posts the video, the second terminal may display the number of the first type of resource transmitted by the second account in first prompt information corresponding to the video.

In some embodiments, the second terminal displays, in the video display interface, the playing accesses of the videos posted by the accounts followed by the second account and second prompt information corresponding to the videos. The second prompt information is used for instructing to transmit, via the resource transmission accesses in the videos, the first type of resource to the accounts that post the videos.

With regard to any video in the video display interface, if the second account has not transmitted the first type of resource to an account that posts the video through the resource transmission access in the video, the second terminal displays the second prompt information corresponding to the video. For example, with regard to a certain video, if the user of the second account has not performed the triggering operation on the resource transmission access in the video, and transmitted the first type of resource of the second account to the account that posts the video, the second terminal may prompt, in the second prompt information corresponding to the video, the second account to transmit the first type of resource to the first account.

In some embodiments, the second terminal displays the first prompt information or the second prompt information corresponding to the video below the playing access of the video. In some embodiments, the second terminal displays the first prompt information or the second prompt information corresponding to the video in a display area of the playing access of the video, or the second terminal may also display the first prompt information or the second prompt information corresponding to the video at other positions, which is not limited herein. In some embodiments, by displaying first prompt information and second prompt information corresponding to the video, it is convenient for the user to know whether the first type of resource has been transmitted to the first account directly according to the prompt information, so that the information content displayed in the video display interface is improved, and the efficiency of interaction between the user and the terminal in the video display interface is improved favorably.

In some embodiments, the second account is associated with the first creature identifier corresponding to the creature in the first video. The second terminal displays, on the basis of the association relationship between the first account and the first creature identifier, the playing access of the video corresponding to the first creature identifier in the video display interface, the video corresponding to the first creature identifier being a video including the creature indicated by the first creature identifier, and plays, in response to the triggering operation for the playing access of the first video in the video display interface, the first video.

The video display interface is used for displaying a playing access of a video corresponding to a creature identifier associated with the second account. The video corresponding to the creature identifier includes a video of the creature indicated by the creature identifier. The creature identifier associated with the second account includes the first creature identifier, so that after the first account posts the first video corresponding to the first creature identifier, the second terminal may display the playing access of the first video in the video display interface. If the user intends to watch the first video corresponding to the playing access, the user performs a triggering operation on the playing access, and the first terminal plays the first video in response to the triggering operation for the playing access.

In some embodiments, the second terminal plays any video corresponding to the first creature identifier posted by the first account before displaying the playing access of the first video in the video display interface. The second terminal displays an association option in the process of playing any video corresponding to the first creature identifier posted by the first account, and establishes, in response to a triggering operation for the association option, the association relationship between the second account and the first creature identifier.

When the first account posts any video corresponding to the first creature identifier, the second account has not yet been associated with the first creature identifier, and the video is a video recommended to the second account for playing. Therefore, in the process of playing any video, the second terminal displays the association option; if the user of the second terminal intends to associate the second account with the first creature identifier corresponding to the creature in the video, the user performs a triggering operation on the association option; the second terminal establishes the association relationship between the second account and the first creature identifier in response to the triggering operation for the association option; and other videos corresponding to the first creature identifier posted by the first account subsequently are all transmitted to the second terminal corresponding to the second account for playing. In some embodiments, the second account is associated with the first creature identifier, and may be equivalent to that the second accounts “adopts” the creature indicated by the first creature identifier, thus achieving the scenario of simulating pet adoption.

In some embodiments, only establishing the association relationship between the second account and the first creature identifier is taken as an example for description. In addition, the first account may also post videos corresponding to other creature identifiers, so that the second account establishes association relationships with other creature identifiers in the process of playing the videos corresponding to other creature identifiers posted by the first account. The first account may post videos corresponding to a plurality of different creatures, and the second account may “adopt” the plurality of different creatures of the first account.

In some embodiments, the second terminal displays the playing access of the first video in the video recommendation interface, and plays, in response to the triggering operation for the playing access of the first video, the first video. The video recommendation interface is used for displaying a playing access of a video recommended to the second account.

In some embodiments, the second terminal determines a creature type corresponding to the first video, and displays the playing access of the first video in the video recommendation interface matching the creature type. The creature type corresponding to the first video refers to the species, such as cat, dog, plant, or the like, to which the creature in the first video belongs. The video recommendation interface matching the creature type refers to an interface used for displaying a playing access of a video corresponding to the creature type. By displaying the playing access of the first video in the video recommendation interface matching the creature type, the playing accesses of the videos is displayed in different types. The playing accesses of the videos of the same creature type are jointly displayed in the same video recommendation interface, so that it is convenient for the user to search the playing accesses of the videos of the specific creature type according to the video recommendation interfaces.

In some embodiments method, the first video includes a plurality of video segments, and the second terminal plays the first video posted by the first account, including: the second terminal sequentially plays the plurality of video segments according to an arrangement order of the plurality of video segments, each video segment including a resource transmission access. The first video is formed by merging a plurality of video segments, and each video segment includes the resource transmission access. Therefore, the first video includes a plurality of resource transmission access. When playing the first video, the second terminal sequentially plays the plurality of video segments in the first video and the resource transmission access in each video segment according to the arrangement order of the plurality of video segments.

It is noted that in some embodiments, it is merely described that the second terminal plays the first video posted by the first account followed by the second account in the video display interface. In another embodiment, the second account needs to follow the first account. The process that the second account follows the first account includes: the second terminal displays a follow option in the process of playing any video posted by the first account, the video being obtained by photographing the real creature; and determine the first account as an account followed by the second account in response to a triggering operation for the follow option.

The video is a video that is posted before the second account follows the first account, and the video is a video recommended to the second account for playing. Therefore, in the process of playing any video, the second terminal displays the follow option; if the user of the second terminal intends to follow the first account on the basis of the second account, the user performs a triggering operation on the follow option, and the second terminal determines, in response to the triggering operation for the follow option, the first account as the account followed by the second account. Other videos posted by the first account subsequently may all be transmitted to the second terminal corresponding to the second account for playing. In some embodiments, the second account follows the first account, which can be equivalent to that the second account “adopts” the creature in the video posted by the first account. For example, if the video posted by the first account including a pet dog, this can be equivalent to that the second account “adopts” the pet dog of the first account. Therefore, after the first account posts the first video including the pet dog, the first video will be transmitted to the second terminal corresponding to the second account, so that the user of the second account plays the first video in time and watches the pet dog in the first video, thereby realizing a scenario of simulating pet adoption.

In some embodiments, the follow option is used for instructing to follow the first account and to transmit the first type of resource to the first account, so that the second terminal determines, in response to the triggering operation for the follow option, the first account as the account followed by the second account, and transmits the first type of resource of the second account to the first account. Or, the follow option corresponds to a target number, and the follow option is used for instructing to follow the first account and to transmit the target number of the first type of resource to the first account, so that the second terminal determines, in response to the triggering operation for the follow option, the first account as the account followed by the second account, and transmits the target number of the first type of resource of the second account to the first account.

In some embodiments, the second terminal establishes a follow relationship between the second account and the first account, and the follow relationship indicates that the second account follows the first account. In some embodiments, after establishing the follow relationship between the second account and the first account, the second terminal transmits the follow relationship to the server, and the server stores the follow relationship between the second account and the first account.

In some embodiments, the second terminal determines the first account as the account followed by the second account and displays a follow notification. The follow notification is used for notifying that the second account has followed the first account, and the user may learn, by reading the follow notification, that the second account has successfully followed the first account, which is equivalent to that the second account has “adopted” the pet of the first account.

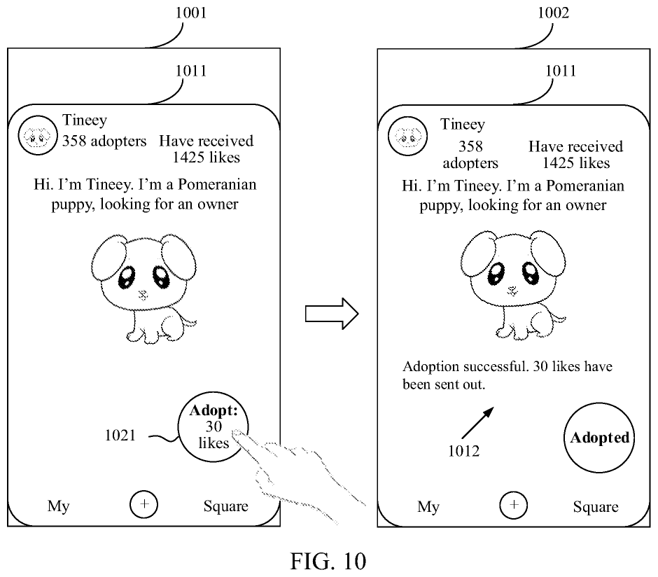

FIG. 10 is a schematic diagram of a process for following an account provided according to some embodiments. The first type of resource is a virtual like. As shown in FIG. 10, a video recommendation interface 1001 of the second account plays a first video 1011 posted by the first account, and displays the follow option 1021. The follow option 1021 corresponds to 30 likes. If the user of the second account intends to follow the first account, the user performs a triggering operation on the follow option 1021. The second terminal determines, in response to the triggering operation for the follow option 1021, the first account as the account followed by the second account, transmits the 30 likes of the second account to the first account, and displays a follow notification 1012 in the video recommendation interface 1002. The follow notification 1012 is “Adoption successful. 30 likes have been sent out”, thus prompting the user of a follow success.

706. The second terminal transmits, in response to a triggering operation for the resource transmission access, the first type of resource of a second account currently logged in to the first account.

In some embodiments, the first account has a resource account corresponding to at least one creature identifier, and the at least one creature identifier at least includes the first creature identifier corresponding to the creature in the first video. The second terminal transmits, in response to the triggering operation for the resource transmission access, the first type of resource of the second account to a first resource account corresponding to the first creature identifier.

The first account can post a video corresponding to at least one creature identifier. In order to distinguish the first type of resource acquired on the basis of the video corresponding to each creature identifier, a resource account corresponding to the at least one creature identifier is established for the first account. The resource account corresponding to each creature identifier is used for storing the first type of resource acquired on the basis of the video corresponding to the creature identifier; and the at least one resource account includes the first resource account corresponding to the first creature identifier. The second terminal determines, in response to the triggering operation for the resource transmission access in the first video, the first creature identifier corresponding to the creature in the first video, queries the first resource account corresponding to the first creature identifier, and transmits the first type of resource of the second account to the first resource account.

In some embodiments, the second terminal converts, in response to the triggering operation for the resource transmission access, a second type of resource of the second account into the first type of resource, and transmits the converted first type of resource to the first account.

The first type of resource and the second type of resource are different types of virtual resources, and the first type of resource is used for being exchanged for a target type of supply used by the creature in the first video; and the first type of resource may be transferred between different accounts, such as being transmitted or received. The first type of resource may be exchanged by the second type of resource, or the first type of resource may be obtained by performing a specified task by a terminal. In some embodiments, the video processing process in some embodiments is completed on the basis of a target client. The first type of resource is a virtual resource circulating in the target client; the second type of resource may be used for being exchanged for the first type of resource; and the second type of resource may also circulate in other clients. For example, the first type of resource is a virtual like, a virtual gift, or the like. The second type of resource is a virtual currency or the like. This is not limited herein.

In some embodiments, the resource transmission access is used for instructing to transmit a first number of first type of resource to the first account, and the second terminal converts, in response to the triggering operation for the resource transmission access, a second number of the second type of resource of the second account into the first number of the first type of resource; and transmits the converted first number of first type of resource to the first account.

For example, the first terminal displays a resource exchange window in response to the triggering operation for the resource transmission access, the resource exchange window including a resource exchange option; converts, in response to a triggering operation for the resource exchange option, the second number of the second type of resource of the second account into the first number of the first type of resource; and transmits the converted first number of the first type of resource to the first account.

For example, the first type of resource is a virtual like, and the second type of resource is a virtual currency. The virtual currency of one yuan can be exchanged for one virtual like. The resource transmission access is used for instructing to transmit 50 virtual likes to the first account, and the second terminal converts, in response to the triggering operation for the resource transmission access, the virtual currency of five yuan of the second account into 50 virtual likes, and transmits the converted 50 virtual likes to the first account.

In some embodiments, the resource transmission access is used for instructing to transmit the first number of the first type of resource to the first account. The second terminal determines a difference value between the first number and the third number as a fourth number in response to the triggering operation for the resource transmission access in a case that a third number of the first type of resource owned by the second account is less than the first number; converts a fifth number of the second type of resource of the second account into the fourth number of the first type of resource; and transmits the first type of resource currently owned by the second account to the first account.

For example, the first terminal displays a resource exchange window in response to the triggering operation for the resource transmission access in a case that the third number of the first type of resource owned by the second account is less than the first number, the resource exchange window including a resource exchange option; determines, in response to a triggering option for the resource exchange option, a difference value between the first number and the third number as a fourth number; converts a fifth number of the second type of resource of the second account into the fourth number of the first type of resource; and transmits the first type of resource currently owned by the second account to the first account.

For example, the first type of resource is a virtual like, and the second type of resource is a virtual currency. The virtual currency of one yuan can be exchanged for one virtual like. The resource transmission access is used for instructing to transmit 100 virtual likes to the first account. The second account currently has 30 virtual likes, and lacks 70 virtual likes. The second terminal converts, in response to the triggering operation for the resource transmission access, the virtual currency of seven yuan of the second account into 70 virtual likes, so that the second account currently has 100 virtual likes; and the second terminal transmits the 100 virtual likes to the first account.

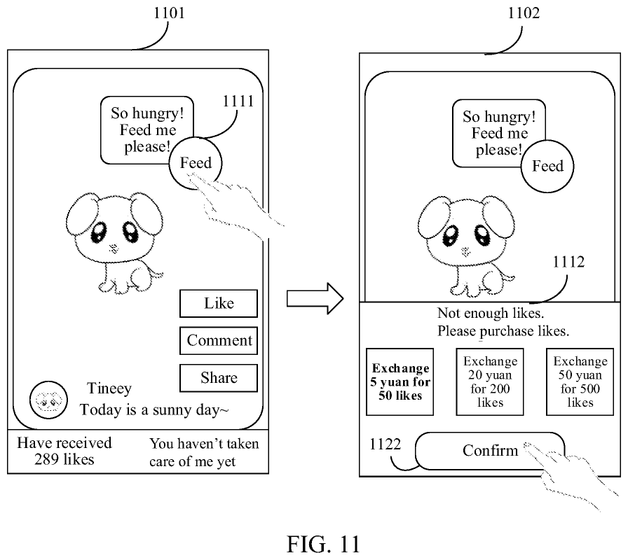

FIG. 11 is a schematic diagram of a process for exchanging a first type of resource provided according to some embodiments. As shown in FIG. 11, the second terminal displays a resource transmission access 1111 in the first video in a video display interface 1101, and displays, in response to a triggering operation for the resource transmission access 1111, a resource exchange window 1112 in the video display interface 1102. The resource exchange window 1112 includes a plurality of resource exchange types, such as “exchange five yuan for 50 likes” and “exchange 20 yuan for 200 likes”. After deciding to select “exchange five yuan for 50 likes”, the user performs a triggering operation on a resource exchange option 1122 in the resource exchange window 1112, and the second terminal converts, in response to the resource exchange option 1122, the virtual currency of five yuan of the second account into 50 likes, and transmits same to the first account.

In some embodiments, the first terminal displays a resource acquisition option in a video display interface of the second account. If the user intends to exchange the second type of resource for the first type of resource, the user performs a triggering operation on the resource acquisition option, and the second terminal displays a resource exchange window in response to the triggering operation for the resource acquisition option, the resource exchange window including a resource exchange option, and converts, in response to a triggering operation for the resource exchange option, the second type of resource of the second account into the first type of resource.

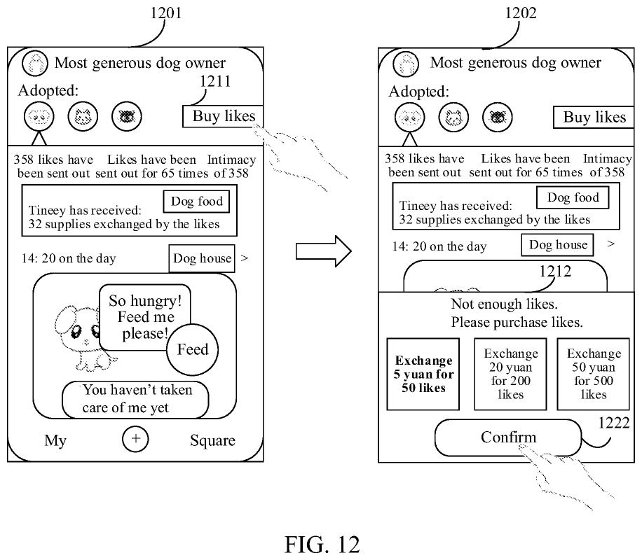

FIG. 12 is a schematic diagram of another process for exchanging a first type of resource provided according to some embodiments. As shown in FIG. 12, the second terminal displays a video display interface 1201 of the second account, the video display interface 1201 including a resource acquisition option 1211; the second terminal displays, in response to a triggering operation for the resource acquisition option 1211, a resource exchange window 1212 in the video display interface 1202. The resource exchange window 1212 includes a plurality of resource exchange types, such as “exchange five yuan for 50 likes” and “exchange 20 yuan for 200 likes”. After deciding to select “exchange five yuan for 50 likes”, the user performs a triggering operation on a resource exchange option 1222 in the resource exchange window 1212, and the second terminal converts, in response to the resource exchange option 1222, the virtual currency of five yuan of the second account into 50 likes.

In some embodiments, the first video further includes a display time point corresponding to the resource transmission access. In the process of playing the first video, the second terminal displays, in response to that a play time point reaches the display time point, the resource transmission access, and pauses the playing of the first video. For example, the display time point corresponding to the resource transmission access is 30 min, which means that the resource transmission access is displayed when a playing duration of the first video is 30 min. In some embodiments, after the second terminal pauses the playing of the first video, the following operation is further included: the second terminal continues to play the first video in response to the triggering operation of the resource transmission access. The second terminal continues to play, in response to the triggering operation on the resource transmission access, the first video after transmitting the first type of resource of the second account to the first account. That is, in the process of playing the first video, the second account needs to pay the first type of resource to the first account to play the complete first video.

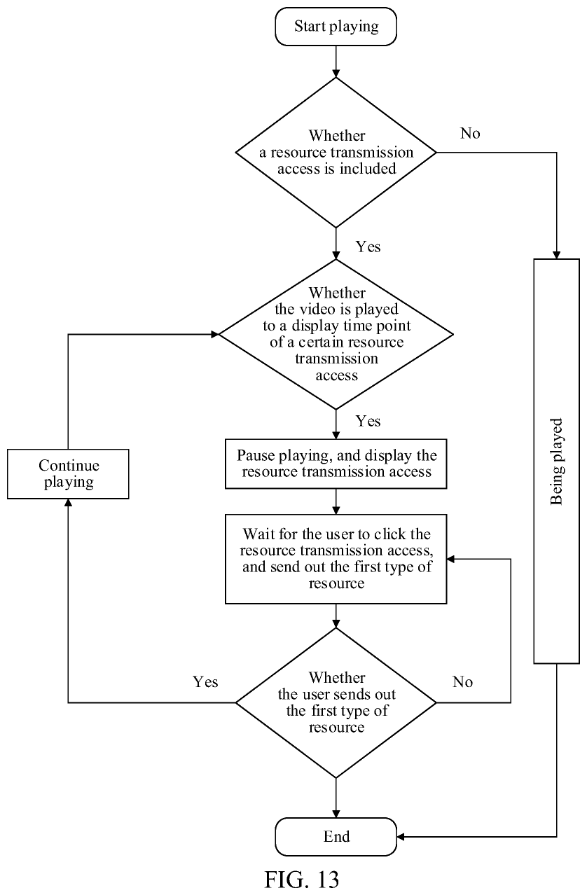

FIG. 13 is a schematic diagram of a process for playing a video provided according to some embodiments. In the process of playing a video, the second terminal determines whether the currently played video includes a resource transmission access; and if the currently played video does not include the resource transmission access, the video is directly played until it ends. If the current video includes the resource transmission access, in the playing process, whether the video is played to the display time point of a certain resource transmission access is determined. When the play time point reaches the display time point of the resource transmission access, the second terminal pauses the playing of the video, displays the resource transmission access for the user to click, and transmits the first type of resource to the first account. The second terminal determines in real time whether the user sends out the first type of resource, and continues to play, if it is determined that the user sends out the first type of resource, the video. The operation of determining whether the video is displayed to the display time point of a certain resource transmission access is executed. The above operations are repeatedly executed until the video ends. If the user does not send out the first type of resource, the second terminal continues to pause the playing of the video, and waits for the user to send out the first type of resource. The above-mentioned operations are repeatedly executed until the video ends.

It is noted that Operation 706 above merely illustrates that the second terminal transmits the first type of resource of the second account to the first account. In another embodiment, the second terminal transmits a resource transmission request to the server in response to the triggering operation for the resource transmission access in the first video. The server receives the resource transmission request transmitted by the second terminal, and transmits the first type of resource of the second account logged in by the second terminal to the first account.

707. The second terminal increases an intimacy parameter between the second account and the first account.

After transmitting the first type of resource of the second account to the first account, the terminal increases the intimacy parameter between the second account and the first account. The intimacy parameter is used for representing the intimacy between the second account and the first account. The second account and the first account are more intimate if the intimacy parameter is larger. The intimacy refers to the interaction between the second account and the first account. The intimacy is higher if the second account has more interactions with the first account. In some embodiments, the interaction between accounts is reflected by setting the intimacy parameter between the accounts, which is favorable for promoting the interaction between the accounts, thus improving the interaction frequency between the user and a video.

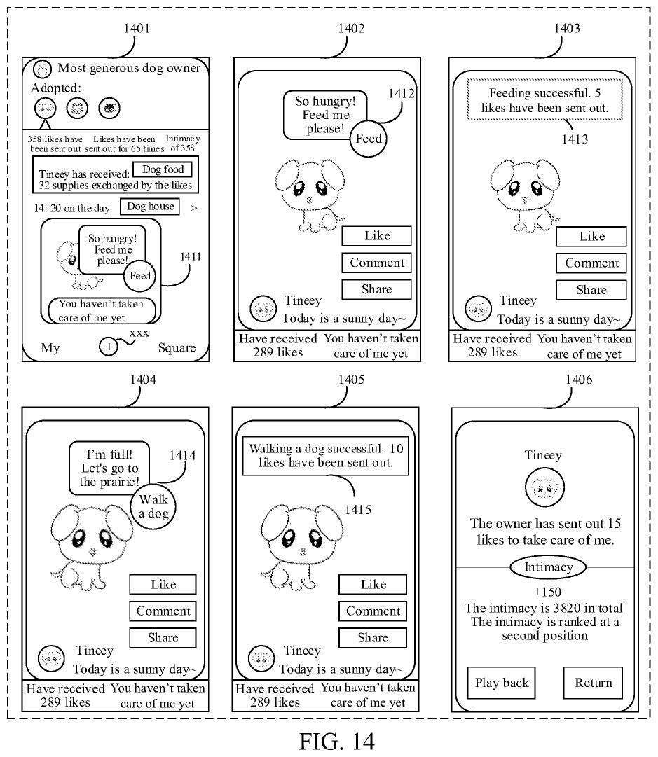

FIG. 14 is a schematic diagram of a process for transmitting a first type of resource provided according to some embodiments. The first type of resource is a virtual like. As shown in FIG. 14, the second terminal displays a playing access 1411 of the first video in a video display interface 1401, plays, in response to a triggering operation for the playing access 1411, the first video in a video display interface 1412, and displays a first resource transmission access 1412 in the first video. The second terminal transmits, in response to a triggering operation for the resource transmission access 1412, five likes of the second account to the first account, and displays prompt information 1413 in a video display interface 1403 to prompt the user that the five likes have been sent out. The second terminal continues to play the first video, displays a second resource transmission access 1414 in the first video in a video display interface 1404, transmits, in response to a triggering operation for the resource transmission access 1414, ten likes of the second account to the first account, and displays prompt information 1415 in a video display interface 1405 to prompt the user that the ten likes have been sent out. After plays the entire first video, the second terminal displays a condition of the intimacy parameter between the second account and the first account in an intimacy display interface 1406. As shown in FIG. 14, the intimacy parameter, added this time, between the second account and the first account, as well as the total number of intimacy parameters between the second account and the first account and the ranking of the intimacy parameters are displayed in the intimacy display interface 1406.

In some embodiments, the second terminal increases the intimacy parameter between an account and a pet identifier in at least one of the following ways:

In the first way, the second terminal increases the intimacy parameter between the second account and the first account in response to a like operation for the first video. If the user feels that the content of the first video is good in the process of watching the first video, the user performs the like operation on the first video, and the second terminal increases the intimacy parameter between the second account and the first account in response to the like operation for the first video. For example, the user gives likes to the first video by double click on the screen while watching the first video.

In the second way, the second terminal increases the intimacy parameter between the second account and the first account in response to a comment operation for the first video. If the user intends to make a comment on the first video in the process of watching the first video, the user performs the comment operation on the first video, and the second terminal increases the intimacy parameter between the second account and the first account in response to the comment operation for the first video. In some embodiments, after the number of the comment operations on the first video reaches a first target number, the user makes a comment on the first video again, and the intimacy parameter between the second account and the first account is not increased.

In the third way, the second terminal increases the intimacy parameter between the second account and the first account in response to a sharing operation for the first video. If the user intends to share the first video in the process of watching the first video, such as forwarding the first video or sharing the first video to other platforms, the user performs the sharing operation on the first video, and the second terminal increases the intimacy parameter between the second account and the first account in response to the sharing operation for the first video. In some embodiments, after the number of the sharing operations on the first video reaches a second target number, the user shares the first video again, and the intimacy parameter between the second account and the first account is not increased.

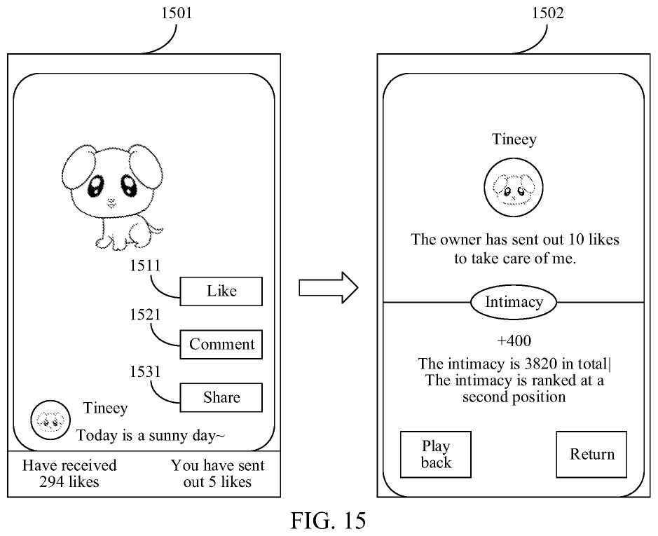

FIG. 15 is a schematic diagram of increasing an intimacy parameter provided according to some embodiments. As shown in FIG. 15, the second terminal plays the first video in a video display interface 1501. In the process of playing the first video, a like option 1511, a comment option 1521, and a sharing option 1531 are also displayed in the video display interface 1501. The user can perform a triggering operation on the like option 1511, the comment option 1521, and the sharing option 1531 to perform a like operation, a comment operation and a sharing operation on the first video respectively, thus increasing the intimacy parameter between the second account and the first account. After playing the entire first video, the second terminal displays the intimacy parameter between the second account and the first account in an intimacy display interface 1502. As shown in FIG. 14, the intimacy parameter, increased in this playing process, between the second account and the first account, as well as the total number of intimacy parameters between the second account and the first account and the ranking of the intimacy parameters are displayed in the intimacy display interface 1406.

It is noted that In some embodiments, the second terminal may also display at least one of the following:

(1) the intimacy parameter between the second account and the first account, where the user can learn the intimacy between the second account and the first account by reading the intimacy parameter;

(2) the number of times that the second account transmits the first type of resource to the first account;

(3) the total number of the first type of resource transmitted from the second account to the first account;

(4) intimacy parameters between other accounts and the first account; and

(5) a plurality of accounts for transmitting the first type of resource to the first account according to an order of the intimacy parameters with the first account from large to small.

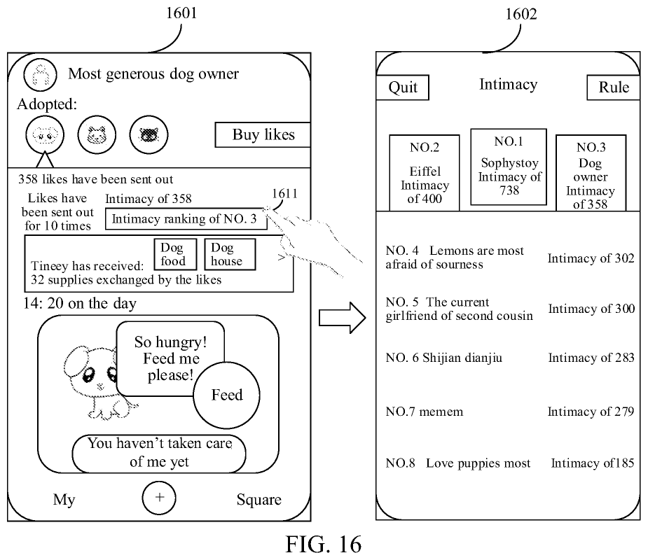

FIG. 16 is a schematic diagram of displaying various kinds of information provided according to some embodiments. The first type of resource is a virtual like. As shown in FIG. 16, the second terminal displays in a video display interface 1601 that the intimacy parameter between the second account and the first account is 358; the number of times that the second account transmits likes to the first account is 10; the total number of likes transmitted by the second account to the first account is 358; the intimacy parameter between the second account and the first account is ranked at the third position; an intimacy view option 1611 is also displayed in the video display interface 1601; and the second terminal displays an intimacy interface 1602 in response to a triggering operation for the intimacy view option 1611. The intimacy parameters between other accounts and the first account is displayed in the intimacy interface 1602, and a plurality of accounts for transmitting the first type of resource to the first account are displayed according to an order of the intimacy parameters with the first account from large to small.

708. The first terminal displays at least one target type of supply and a corresponding number of each target type of supply.

The first terminal displays the at least one target type of supply and the corresponding number of each target type of supply. The target type of supply refers to an item which can be used by the real creature. For example, the target type of supply is dog food, cat food, cat house, or the like. The corresponding number of the target type of supply refers to the number of the first type of resource required to be exchanged for the target type of supply. In some embodiments, the first terminal displays an item exchange interface, and the item exchange interface includes the at least one target type of supply and the corresponding number of each target type of supply.

In some embodiments, only the following situation is taken as an example for illustration: after the second account transmits the first type of resource to the first account, the first terminal displays the at least one target type of supply and the corresponding number of each target type of supply. In another embodiment, the first terminal may also display at least one target type of supply and a corresponding number of each target type of supply under other conditions. That is, the execution timing of operation 708 above is not limited.

709. The first terminal transmits an exchange request for any target type of supply to the server in response to an exchange operation for any target type of supply.

If the user of the first terminal intends to exchange the first type of resource for a certain target type of supply, the user performs a triggering operation for the target type of supply, and the first terminal transmits the exchange request for the target type of supply to the server in response to the exchange operation for the target type of supply. The exchange request carries the first account and the target type of supply, and the exchange request is used for requesting to exchange the first type of resource of the first account for the target type of supply.

710. The server receives the exchange request transmitted by the first terminal corresponding to the first account, generates an order containing the first account and the target type of supply, and deducts a number of the first type of resource corresponding to any target type of supply from the first account.

The order is used for instructing to supply the target type of supply to an owner of the first account. After deducting a number of the first type of resource corresponding to any target type of supply from the first account, the server may subsequently supply the target type of supply to the owner of the first account on line on the basis of the order, so that the owner of the first account exchanges the first type of resource for a real item.

It is noted that in another embodiment, the server may also generate an exchange record for exchanging the target type of supply by the first account, the exchange record including the first account and the target type of supply exchanged by the first account, and transmit the exchange record to the second terminal. The second terminal receives the exchange record transmitted by the server, and displays the first account and the target type of supply exchanged by the first account.

It is noted that Operations 709-710 above are only described by taking the following situation as an example: the server generates an order and deducts the first type of resource corresponding to any target type of supply. In another embodiment, the first terminal generates, in response to an exchange operation for any target type of supply, an order containing the first account and the target type of supply, and deducts a number of the first type of resource corresponding to the target type of supply from the first account.

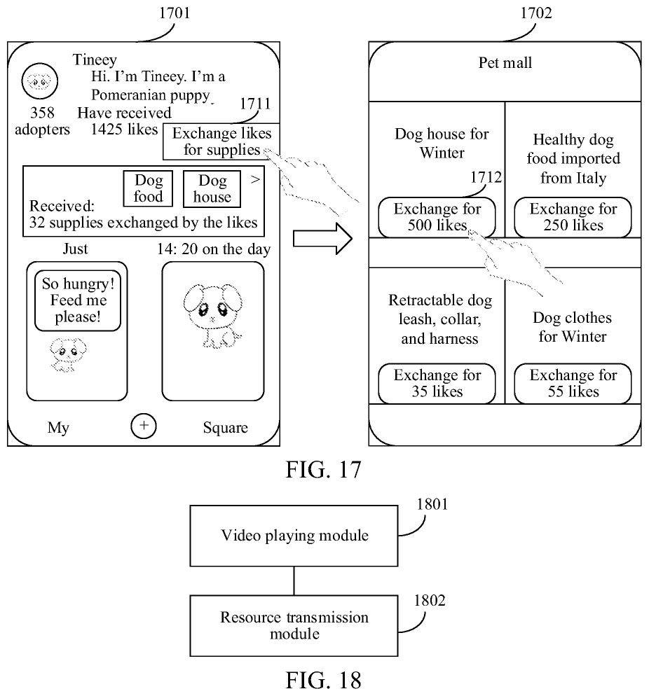

FIG. 17 is a schematic diagram of a process for exchanging a target type of supply provided according to some embodiments. The first type of resource is a virtual like. As shown in FIG. 17, the first terminal displays a resource exchange option 1711 in a main interface 1701 of the first account. If the user intends to exchange the virtual likes for the target type of supply, the user performs a triggering operation on the resource exchange option 1711. The first terminal displays a supply display interface 1702 in response to the triggering operation for the resource exchange option 1711. The supply display interface 1702 includes a plurality of target types of supplies and a corresponding number of each target type of supply. For example, target types of supplies such as a dog house, dog food, a dog leash, and dog clothes are shown in FIG. 17. Each target type of supply corresponds to an exchange option 1712. If the user intends to exchange a certain target type of supply, the user performs a triggering operation on the exchange option 1712 corresponding to the target type of supply; and the first terminal generates, in response to the triggering operation for the exchange option 1712 corresponding to the target type of supply, an order containing the first account and the target type of supply, and deducts a number of virtual likes corresponding to the target type of supply from the first account.

In the related technology, in a game for raising a virtual pet, the user upgrades the virtual pet by performing a task in the game, and the user can get a corresponding reward after the virtual pet is upgraded. However, in the above-mentioned raising process, since the virtual pet is not real, the virtual pet lacks emotion, sound, etc. of a real pet, and lacks the sense of reality, and the user cannot feel an interaction process with the real pet. The sense of satisfaction of the user in such a game mode is relatively weak. Furthermore, the user can raise only one kind of virtual pet and use one raising mode, so that the raising process is dull. There is no chance for the user to select different kinds of pets. In addition, the terminal needs to provide an additional page for performing a task for the user to perform tasks to upgrade the virtual pet, which occupies additional terminal running resources.

Since the first video includes a real creature, the user of the second terminal can directly pay the first type of resource to the account posting the first video in the process of playing the first video. The first type of resource can be exchanged for a real target type of supply. In this manner of directly transmitting the first type of resource to the first account through the resource transmission access in the first video in the process of playing the video, the user can get real benefits to the account posting the video in the process of watching the video. Compared with an existing manner that the user needs to perform game tasks to obtain resources for a virtual creature, or that resources are transmitted through an additional resource interface, this manner is more convenient, without skipping to other interfaces to transmit resources, so that the running resources of the terminal can be saved.

Furthermore, by displaying the playing access of the first video in the video recommendation interface matching the creature type, the playing accesses of the videos is displayed in different types. The playing accesses of the videos of the same creature type are jointly displayed in the same video recommendation interface, so that it is convenient for the user to search the playing accesses of the videos of the specific creature type according to the video recommendation interfaces.

FIG. 18 is a schematic structural diagram of a video processing apparatus provided according to some embodiments. Referring to FIG. 18, the apparatus includes:

a video playing module 1801, configured to play a first video posted by a first account, the first video being obtained by photographing a real creature, the first video including a resource transmission access, the resource transmission access being used for instructing to transmit a first type of resource to the first account, and the first type of resource being used for being exchanged for a target type of supply used by the creature in the first video; and

a resource transmission module 1802, configured to transmit, in response to a triggering operation for the resource transmission access, the first type of resource of a second account currently logged in to the first account.

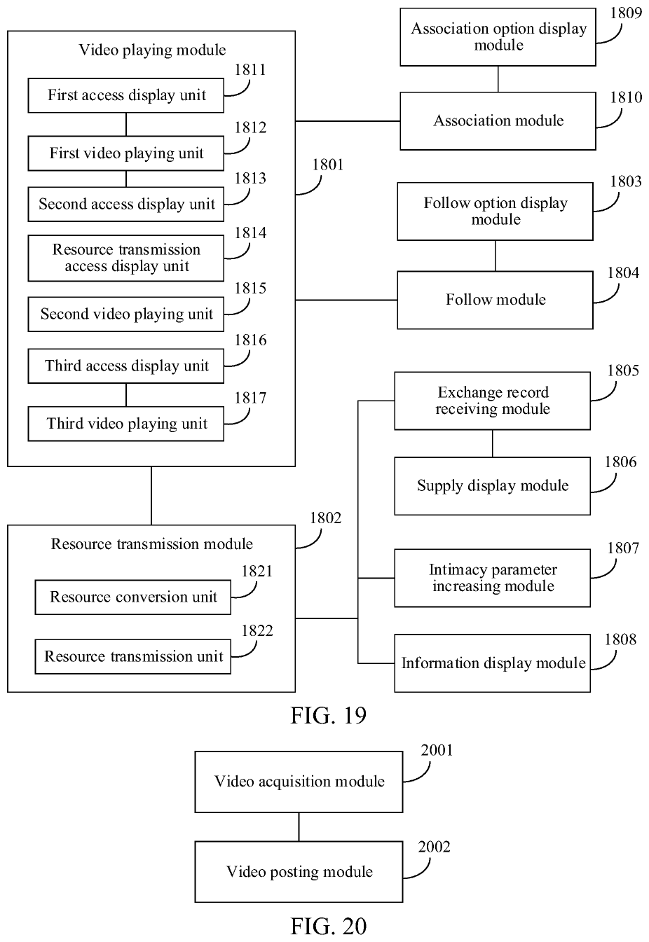

In some embodiments, referring to FIG. 19, the first account is an account followed by the second account, and the video playing module 1801 includes:

a first access display unit 1811, configured to display playing accesses of videos posted by the account followed by the second account in a video display interface, the videos posted by the account followed by the second account at least including the first video; and

a first video playing unit 1812, configured to play the first video in response to a triggering operation for the playing access of the first video.

In some embodiments, referring to FIG. 19, the first access display unit 1811 is configured to:

display, in the video display interface, the playing accesses of the videos posted by the account followed by the second account and first prompt information corresponding to the videos, the first prompt information including the number of the first type of resource transmitted, through the resource transmission accesses in the videos, by the second account to the account that posts the videos.

In some embodiments, referring to FIG. 19, the first access display unit 1811 is configured to:

display, in the video display interface, the playing accesses of the videos posted by the account followed by the second account and second prompt information corresponding to the videos, the second prompt information being used for instructing to transmit, via the resource transmission accesses in the videos, the first type of resource to the account that posts the videos.

In some embodiments, referring to FIG. 19, the apparatus further includes:

a follow option display module 1803, configured to display a follow option in the process of playing any video posted by the first account, the video being obtained by photographing the real creature; and

a follow module 1804, configured to determine the first account as the account followed by the second account in response to a triggering operation for the follow option.

In some embodiments, referring to FIG. 19, the video playing module 1801 includes:

a second access display unit 1813, configured to display the playing access of the first video on the video recommendation interface, the video recommendation interface being used for displaying a playing access of a video recommended to the second account; and

a first video playing unit 1812, configured to play the first video in response to a triggering operation for the playing access of the first video.

In some embodiments, referring to FIG. 19, the second access display unit 1813 is configured to:

determine a creature type corresponding to the first video; and

display the playing access of the first video in the video recommendation interface matching the creature type.

In some embodiments, referring to FIG. 19, the first video also includes a display time point corresponding to the resource transmission access, and the video playing module 1801 includes:

a resource transmission access display unit 1814, configured to display, in response to that a play time point reaches a display time point in the process of playing the first video, the resource transmission access, and pause the playing of the first video; and

a second video playing unit 1815, configured to continue to play the first video in response to the triggering operation for the resource transmission access.

In some embodiments, referring to FIG. 19, the first video includes a plurality of video segments, and the video playing module 1801 includes:

a second video playing unit 1815, configured to sequentially play the plurality of video segments according to an arrangement order of the plurality of video segments, each video segment including a resource transmission access.

In some embodiments, referring to FIG. 19, the resource transmission module 1802 includes:

a resource conversion unit 1821, configured to convert, in response to the triggering operation for the resource transmission access, a second type of resource of the second account into the first type of resource, and transmit the converted first type of resource to the first account.

In some embodiments, referring to FIG. 19, the resource transmission access is used for instructing to transmit a first number of the first type of resource to the first account, and the resource conversion unit 1821 is configured to:

convert, in response to the triggering operation for the resource transmission access, a second number of the second type of resource of the second account into the first number of the first type of resource; and

transmit the converted first number of first type of resource to the first account.

In some embodiments, referring to FIG. 19, the resource conversion unit 1821 is configured to:

determine a difference value between the first number and the third number as a fourth number in response to the triggering operation for the resource transmission access in a case that a third number of the first type of resource owned by the second account is less than the first number;

convert a fifth number of the second type of resource of the second account into the fourth number of the first type of resource; and

transmit the first type of resource currently owned by the second account to the first account.

In some embodiments, referring to FIG. 19, the apparatus further includes:

an exchange record receiving module 1805, configured to receive an exchange record transmitted by a server, the exchange record including the first account and the target type of supply which has been exchanged by the first account, and the target type of supply being exchanged with the first type of resource by the first account; and

a supply display module 1806, configured to display the first account and the target type of supply which has been exchanged by the first account.

In some embodiments, referring to FIG. 19, the apparatus further includes:

an intimacy parameter increasing module 1807, configured to increase an intimacy parameter between the second account and the first account, the intimacy parameter being used for representing the intimacy between the second account and the first account.

In some embodiments, referring to FIG. 19, the apparatus further includes the intimacy parameter increasing module 1807, the intimacy parameter increasing module 1807 being configured to perform at least one of the following:

increasing the intimacy parameter between the second account and the first account in response to a like operation for the first video;

increasing the intimacy parameter between the second account and the first account in response to a comment operation for the first video; and

increasing the intimacy parameter between the second account and the first account in response to a sharing operation for the first video.

In some embodiments, referring to FIG. 19, the apparatus further includes an information display module 1808, the information display module 1808 being further configured to perform at least one of the following:

displaying the intimacy parameter between the second account and the first account;

displaying the number of times that the second account transmits the first type of resource to the first account;

displaying the total number of the first type of resource transmitted from the second account to the first account;

displaying intimacy parameters between other accounts and the first account; and

displaying a plurality of accounts for transmitting the first type of resource to the first account according to an order of the intimacy parameters with the first account from large to small.

In some embodiments, referring to FIG. 19, the second account is associated with a first creature identifier corresponding to the creature in the first video, and the video playing module 1801 includes:

a third access display unit 1816, configured to display, on the basis of an association relationship between the first account and the first creature identifier, a playing access of a video corresponding to the first creature identifier in a video display interface, the video corresponding to the first creature identifier being a video including the creature indicated by the first creature identifier; and

a third video playing unit 1817, configured to play the first video in response to a triggering operation for the playing access of the first video in the video display interface.

In some embodiments, referring to FIG. 19, the apparatus further includes:

an association option display module 1809, configured to display an association option in the process of playing any video posted by the first account and corresponding to the first creature identifier; and

an association module 1810, configured to establish an association relationship between the second account and the first creature identifier in response to a triggering operation for the association option.

In some embodiments, referring to FIG. 19, the first account has a resource account corresponding to at least one creature identifier, and the at least one creature identifier at least includes the first creature identifier corresponding to the creature in the first video. The resource transmission module 1802 includes:

a resource transmission unit 1822, configured to transmit, in response to the triggering operation for the resource transmission access, the first type of resource of the second account to a first resource account corresponding to the first creature identifier.

FIG. 20 is a schematic structural diagram of a video processing apparatus provided according to some embodiments. Referring to FIG. 20, the apparatus includes:

a video acquisition module 2001, configured to acquire a first video on the basis of a first account currently logged in, the first video being obtained by photographing a real creature, the first video including a resource transmission access, the resource transmission access being used for instructing to trigger an account of the resource transmission access to transmit a first type of resource to the first account, and the first type of resource being used for being exchanged with a target type of supply used by the creature in the first video; and

a video posting module 2002, configured to post the first video on the basis of the first account, a second terminal that plays the first video being configured to transmit, in response to a triggering operation for the resource transmission access, the first type of resource of a second account currently logged in to the first account.

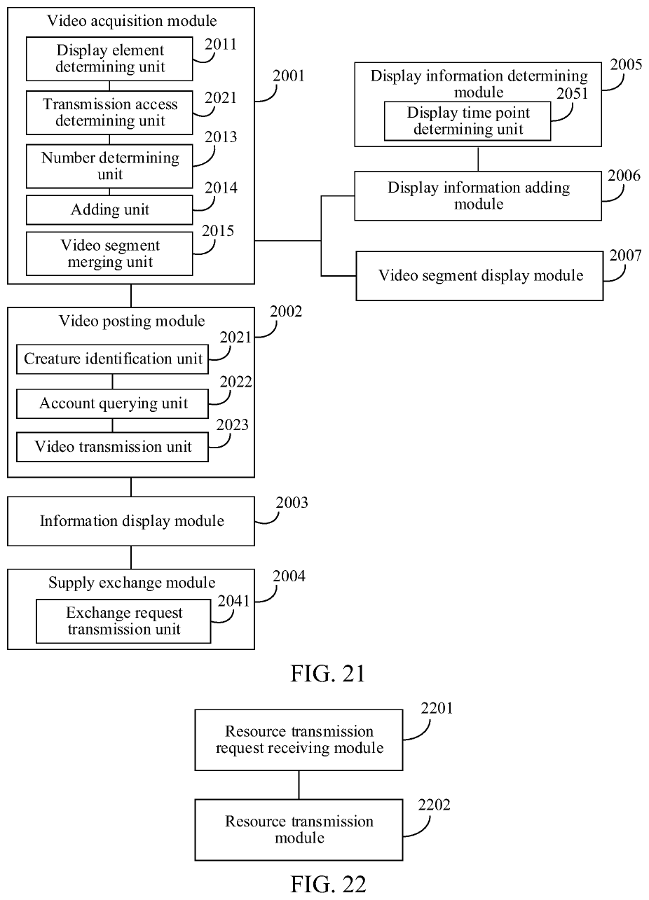

In some embodiments, referring to FIG. 21, the apparatus further includes:

an information display module 2003, configured to display at least one target type of supply and a corresponding number of each target type of supply;

a supply exchange module 2004, configured to generate, in response to an exchange operation for any target type of supply, an order containing the first account and the target type of supply, the order being used for instructing to provide the target type of supply to an owner of the first account, and deducting a number of the first type of resource corresponding to the target type of supply from the first account.

In some embodiments, referring to FIG. 21, the supply exchange module 2004 includes:

an exchange request transmission unit 2041, configured to transmit, in response to an exchange operation for any target type of supply, an exchange request for the target type of supply to the server, the server being configured to generate, in response to the exchange request, an order containing the first account and the target type of supply, and deduct a number of the first type of resource corresponding to the target type of supply from the first account.

In some embodiments, referring to FIG. 21, the video acquisition module 2001 includes:

a display element determining unit 2011, configured to acquire, in response to an access adding operation for an original video, a target display element input to an input box, or select, in response to an access adding operation for an original video, a target display element from a plurality of standby display elements;

a transmission access determining unit 2012, configured to determine a target display element as a resource transmission access;

a number determining unit 2013, configured to determine a first number corresponding to the resource transmission access; and

an adding unit 2014, configured to add the resource transmission access and the first number to an original video to obtain the first video.

In some embodiments, referring to FIG. 21, the apparatus further includes:

a display information determining module 2005, configured to determine display information corresponding to the resource transmission access, the display information being used for indicating a display manner of the resource transmission access; and

a display information adding module 2006, configured to add the display information to the original video to obtain the first video.

In some embodiments, referring to FIG. 21, the display information includes a display time point, and the display information determining module 2005 includes:

a display time point determining unit 2051, configured to display a play progress bar, and determine a play time point selected from the play progress bar as the display time point corresponding to the resource transmission access.

In some embodiments, referring to FIG. 21, the video acquisition module 2001 includes:

a video segment merging unit 2015, configured to acquire a plurality of video segments, and merge the plurality of video segments into the first video, each video segment includes a creature and a resource transmission access.

In some embodiments, referring to FIG. 21, the video segment merging unit 2014 is configured to:

display a video adding option on a video editing interface; and

acquire one video segment at each time in response to a triggering operation for the video adding option, until the plurality of acquired video segments are merged into the first video in response to a video segment merging operation.

In some embodiments, referring to FIG. 21, the apparatus further includes:

a video segment display module 2007, configured to display, after acquiring one video segment in response to the triggering operation for the video adding option at each time, the video segment acquired this time, and cancel displaying the video adding option; and

the video segment merging unit 2015 is further configured to re-display the video adding option in response to a sliding operation for the currently displayed video segment.

In some embodiments, referring to FIG. 21, the video posting module 2002 includes:

a creature identification unit 2021, configured to identify a creature in the first video to obtain a first creature identifier, the first creature identifier indicating the creature in the first video;

an account querying unit 2022, configured to query at least one account associated with the first creature identifier, the at least one account at least including the second account; and

a video transmission unit 2023, configured to transmit the first video to a terminal corresponding to the at least one account.

FIG. 22 is a schematic structural diagram of a video processing apparatus provided according to some embodiments. Referring to FIG. 22, the apparatus includes:

a resource transmission request receiving module 2201, configured to receive a resource transmission request, the resource transmission request being transmitted by a second terminal in response to a triggering operation for a resource transmission access in the first video, the first video being obtained by photographing a real creature, the resource transmission access being used for instructing to transmit a first type of resource to a first account that posts the first video, and the first type of resource being used for being exchanged for a target type of supply used by the creature in the first video; and

a resource transmission module 2202, configured to transmit the first type of resource of a second account logged in by the second terminal to the first account.

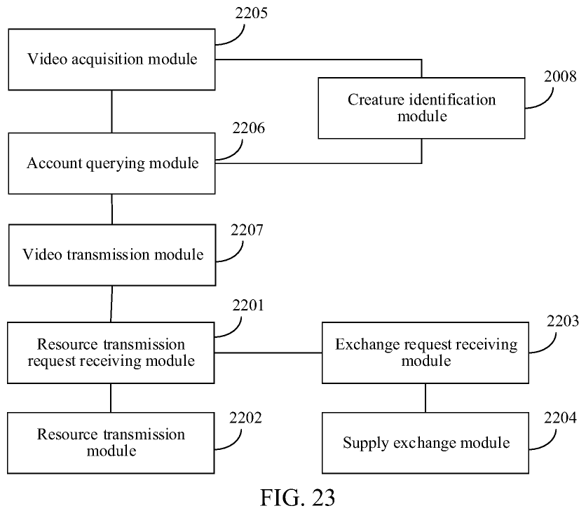

In some embodiments, referring to FIG. 23, the apparatus further includes:

an exchange request receiving module 2203, configured to receive an exchange request transmitted by a first terminal corresponding to the first account, the exchange request carrying the first account and the target type of supply; and

a supply exchange module 2204, configured to generate an order containing the first account and the target type of supply, the order being used for instructing to provide the target type of supply to an owner of the first account, and deducting a number of the first type of resource corresponding to the target type of supply from the first account.

In some embodiments, referring to FIG. 23, the apparatus further includes:

a video acquisition module 2205, configured to acquire the first video transmitted by the first terminal corresponding to the first account;

an account querying module 2206, configured to query a second account that follows the first account; and

a video transmission module 2207, configured to transmit the first video to a second terminal corresponding to the second account.

In some embodiments, referring to FIG. 23, the apparatus further includes:

a video acquisition module 2205, configured to acquire the first video transmitted by the first terminal corresponding to the first account and a creature type corresponding to the first video;

a video transmission module 2207, configured to transmit the first video and the creature type to the second terminal, the second terminal being configured to display a playing access of the first video in a video recommendation interface, and the video recommendation interface being used for displaying the playing access of the video which is recommended to the second account and corresponds to the creature type.

In some embodiments, referring to FIG. 23, the apparatus further includes:

a video acquisition module 2205, configured to acquire the first video transmitted by the first terminal corresponding to the first account;

a creature identification module 2208, configured to identify a creature in the first video to obtain a first creature identifier, the first creature identifier indicating the creature in the first video;

an account querying module 2206, configured to query at least one account associated with the first creature identifier, the at least one account at least including the second account; and

a video transmission module 2207, configured to transmit the first video to a terminal corresponding to the at least one account.

It is noted that when the video processing apparatus processes videos, the foregoing embodiment is merely described by using an example of dividing various functional modules. In some embodiments, the foregoing functions may be allocated to and completed by different functional modules according to requirements. That is, an internal structure of the server is divided into different functional modules, to complete all or some of the functions described above. In addition, the video processing apparatus provided in the foregoing embodiment belongs to the same conception as the embodiment of the video processing method. For the specific implementation process, reference may be made to the method embodiments, and details are not described herein again.

Some embodiments further provide a computer device, including a processor and a memory, the memory storing at least one computer program, the at least one computer program being loaded and executed by a processor to implement operations performed in the video processing method of the foregoing embodiments.

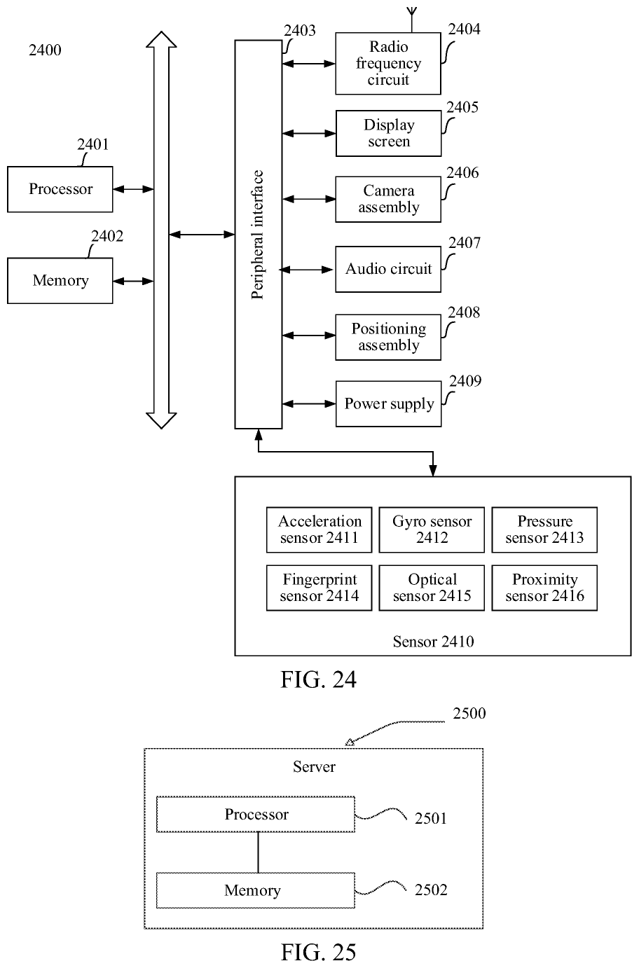

In some embodiments, the computer device is provided as a terminal. FIG. 24 illustrates a schematic structural diagram of a terminal 2400 provided according to some embodiments. The terminal 2400 includes: a processor 2401 and a memory 2402. The processor 2401 may include one or more processing cores, such as, a 4-core processor or an 8-core processor.

The memory 2402 may include one or more computer-readable storage media that may be non-transitory. The memory 2402 may further include a high-speed random access memory (RAM), and a non-volatile memory such as one or more magnetic disk storage devices or flash storage devices. In some embodiments, the non-transient computer-readable storage medium in the memory 2402 is configured to store at least one computer-readable instruction, and the at least one computer-readable instruction is configured to be executed by the processor 2401 to implement the video processing method provided in the foregoing method embodiments.

In some embodiments, the terminal 2400 may further, in some embodiments, include: a peripheral interface 2403 and at least one peripheral device. The processor 2401, the memory 2402, and the peripheral interface 2403 may be connected through a bus or a signal cable. Each peripheral device may be connected to the peripheral interface 2403 through a bus, a signal cable, or a circuit board. In some embodiments, the peripheral device includes: at least one of a radio frequency (RF) circuit 2404, a display screen 2405, a camera assembly 2406, an audio circuit 2407, a positioning assembly 2408, and a power supply 2409.

In some embodiments, the terminal 2400 further includes one or more sensors 2410. The one or more sensors 2410 include but are not limited to: an acceleration sensor 2411, a gyro sensor 2412, a pressure sensor 2413, a fingerprint sensor 2414, an optical sensor 2415, and a proximity sensor 2416.

A person skilled in the art may understand that the structure shown in FIG. 24 constitutes no limitation on the terminal 2400, and the terminal may include more or fewer components than those shown in the figure, or some components may be combined, or a different component deployment may be used.

In some embodiments, the computer device is provided as a server. FIG. 25 is a schematic structural diagram of a server according to some embodiments. The server 2500 may vary greatly due to different configurations or performance, and may include one or more processors (central processing units (CPUs)) 2501 and one or more memories 2502. The memory 2502 stores at least one computer-readable instruction, the at least one computer-readable instruction being loaded and executed by the processor 2501 to implement the methods provided in the foregoing method embodiments. Certainly, the server may further include components such as a wired or wireless network interface, a keyboard, and an input/output interface, to facilitate inputs/outputs. The server may further include another component configured to implement a function of a device, and details are not described herein again.

Some embodiments further provide a non-transitory computer-readable storage medium storing computer-readable instructions, the computer-readable instructions, when executed by one or more processors, implementing operations performed in the video processing method of the foregoing embodiments.

Some embodiments further provide a computer program product or a computer program, including a computer program code, the computer program code being stored in a computer-readable storage medium. A processor of a computer device reads the computer program code from the computer-readable storage medium, and executes the computer program code, causing the computer device to implement operations performed in the video processing method of the foregoing embodiments.

A person of ordinary skill in the art may understand that all or some of the operations of the foregoing embodiments may be implemented by hardware, or may be implemented by a program instructing related hardware. The program may be stored in a computer-readable storage medium. The storage medium may be: a read-only memory, a magnetic disk, an optical disc, or the like.

The foregoing descriptions are merely optional embodiments of the embodiments of the disclosure, but are not intended to limit the embodiments of the disclosure. Any modification, equivalent replacement, or improvement made within the spirit and principle of the embodiments of the disclosure shall fall within the protection scope of the disclosure.

What is claimed is:

1. A video processing method, performed by a computer device, the video processing method comprising:
playing a first video posted by a first account, the first video being obtained by photographing a real creature, the first video comprising a resource transmission access, the resource transmission access instructing to transmit a first type of resource to the first account, and the first type of resource being exchanged for a target type of supply used by the real creature in the first video; and
transmitting, based on a triggering operation for the resource transmission access during the playing of the first video, the first type of resource of a second account currently logged in to the first account.

2. The video processing method according to claim 1, wherein the second account is associated with a first creature identifier corresponding to the real creature in the first video, and the playing comprises:
displaying, based on an association relationship between the first account and the first creature identifier, a playing access of a video corresponding to the first creature identifier in a video display interface, the video corresponding to the first creature identifier being a video comprising the real creature indicated by the first creature identifier; and
playing the first video based on a triggering operation for the playing access of the first video in the video display interface.

3. The video processing method according to claim 2, wherein before the playing the first video posted by the first account, the video processing method further comprises:
displaying an association option during playing of any video posted by the first account and corresponding to the first creature identifier; and
establishing an association relationship between the second account and the first creature identifier based on a triggering operation for the association option.

4. The video processing method according to claim 1, wherein the first account has a resource account corresponding to at least one creature identifier, and the at least one creature identifier at least comprises a first creature identifier corresponding to the real creature in the first video; and
the transmitting comprises:
transmitting, based on the triggering operation for the resource transmission access, the first type of resource of the second account to a first resource account corresponding to the first creature identifier.

5. The video processing method according to claim 1, further comprising:
displaying a follow option during the playing of any video posted by the first account, the video being obtained by photographing the real creature and the any video being a video posted when the second account has not followed the first account; and
determining, based on a triggering operation for the follow option, that the first account is an account followed by the second account.

6. The video processing method according to claim 1, wherein the first account is an account followed by the second account, and the playing comprises:
displaying playing accesses of videos posted by the account followed by the second account in a video display interface, the videos posted by the account followed by the second account at least comprising the first video; and
playing the first video based on a triggering operation for the playing accesses of the first video.

7. The video processing method according to claim 1, wherein the first video further comprises a display time point corresponding to the resource transmission access, and the playing comprises:
displaying, based on a play time point reaching the display time point during the playing of the first video, the resource transmission access, and pausing the playing of the first video; and
continuing to play the first video based on the triggering operation for the resource transmission access.

8. The video processing method according to claim 1, wherein the transmitting comprises:
converting, based on the triggering operation for the resource transmission access, a second type of resource of the second account into the first type of resource, and transmitting the converted first type of resource to the first account.

9. The video processing method according to claim 1, further comprising:
receiving an exchange record transmitted by a server, the exchange record comprising the first account and the target type of supply which has been exchanged by the first account, and the target type of supply being exchanged with the first type of resource by the first account; and
displaying the first account and the target type of supply which has been exchanged by the first account.

10. A video processing apparatus, further comprising:
at least one memory configured to store program code; and
at least one processor configured to read the program code and operate as instructed by the program code, the program code comprising:
video playing code configured to cause at least one of the at least one processor to play a first video posted by a first account, the first video being obtained by photographing a real creature, the first video comprising a resource transmission access, the resource transmission access instructing to transmit a first type of resource to the first account, and the first type of resource being exchanged for a target type of supply used by the real creature in the first video; and
resource transmission code configured to cause at least one of the at least one processor to transmit, based on a triggering operation for the resource transmission access during the playing of the first video, the first type of resource of a second account currently logged in to the first account.

11. The video processing apparatus according to claim 10, wherein the second account is associated with a first creature identifier corresponding to the real creature in the first video, and the video playing code is further configured to cause at least one of the at least one processor to:
display, based on an association relationship between the first account and the first creature identifier, a playing access of a video corresponding to the first creature identifier in a video display interface, the video corresponding to the first creature identifier being a video comprising the real creature indicated by the first creature identifier; and
play the first video based on a triggering operation for the playing access of the first video in the video display interface.

12. The video processing apparatus according to claim 11, wherein before the play the first video posted by the first account, the program code further comprises:
association option display code configured to cause at least one of the at least one processor to display an association option during playing of any video posted by the first account and corresponding to the first creature identifier; and
association code configured to cause at least one of the at least one processor to establish an association relationship between the second account and the first creature identifier based on a triggering operation for the association option.

13. The video processing apparatus according to claim 10, wherein the first account has a resource account corresponding to at least one creature identifier, and the at least one creature identifier at least comprises a first creature identifier corresponding to the real creature in the first video; and
the resource transmission code is further configured to cause at least one of the at least one processor to:
transmit, based on the triggering operation for the resource transmission access, the first type of resource of the second account to a first resource account corresponding to the first creature identifier.

14. The video processing apparatus according to claim 10, wherein the program code further comprises:
follow option display code configured to cause at least one of the at least one processor to display a follow option during the playing of any video posted by the first account, the video being obtained by photographing the real creature; and
follow code configured to cause at least one of the at least one processor to determine, based on a triggering operation for the follow option, that the first account is an account followed by the second account.

15. The video processing apparatus according to claim 10, wherein the first account is an account followed by the second account, and the video playing code is further configured to cause at least one of the at least one processor to:
display playing accesses of videos posted by the account followed by the second account in a video display interface, the videos posted by the account followed by the second account at least comprising the first video; and
play the first video based on a triggering operation for the playing accesses of the first video.

16. The video processing apparatus according to claim 10, wherein the first video further comprises a display time point corresponding to the resource transmission access, and the video playing code is further configured to cause at least one of the at least one processor to:
display, based on a play time point reaching the display time point during the playing of the first video, the resource transmission access, and pause the playing of the first video; and
continue to play the first video based on the triggering operation for the resource transmission access.

17. The video processing apparatus according to claim 10, wherein the resource transmission code is further configured to cause at least one of the at least one processor to:
convert, based on the triggering operation for the resource transmission access, a second type of resource of the second account into the first type of resource, and transmit the converted first type of resource to the first account.

18. The video processing apparatus according to claim 10, wherein the program code further comprises:
exchange record receiving code configured to cause at least one of the at least one processor to receive an exchange record transmitted by a server, the exchange record comprising the first account and the target type of supply which has been exchanged by the first account, and the target type of supply being exchanged with the first type of resource by the first account; and
supply display conde configured to cause at least one of the at least one processor to display the first account and the target type of supply which has been exchanged by the first account.

19. A non-transitory computer-readable storage medium storing computer code that, when executed by at least one processor, causes the at least one processor to at least:
play a first video posted by a first account, the first video being obtained by photographing a real creature, the first video comprising a resource transmission access, the resource transmission access instructing to transmit a first type of resource to the first account, and the first type of resource being exchanged for a target type of supply used by the real creature in the first video; and
transmit, based on a triggering operation for the resource transmission access during the playing of the first video, the first type of resource of a second account currently logged in to the first account.

20. The non-transitory computer-readable storage medium according to claim 19, wherein the second account is associated with a first creature identifier corresponding to the real creature in the first video, and the play the first video posted by the first account comprises:
displaying, based on an association relationship between the first account and the first creature identifier, a playing access of a video corresponding to the first creature identifier in a video display interface, the video corresponding to the first creature identifier being a video comprising the real creature indicated by the first creature identifier; and
playing the first video based on a triggering operation for the playing access of the first video in the video display interface.
